(19) United States
(12) Patent Application Publication
(10) Pub. No.: US 2005/0060283 A1
(43) Pub. Date: Mar. 17, 2005

(54) Content management system for creating and maintaining a database of information utilizing user experiences

(76) Inventors: Gregory J. Petras, Phoenix, AZ (US); Lisa J. Cramer, Phoenix, AZ (US); Andrew F. Mason, Phoenix, AZ (US); Lisa L. Leonard, Phoenix, AZ (US)

Correspondence Address: STONEMAN LAW OFFICES, LTD, 3113 NORTH 3RD STREET, PHOENIX, AZ, 85012, US

(21) Appl. No.: 10/944,495

(22) Filed: Sep. 16, 2004

Related U.S. Application Data
(60) Provisional application No. 60/504,306, filed on Sep. 17, 2003.

(51) Int. Cl. G06F 7/00

(52) U.S. Cl. 707/1

(57) ABSTRACT

A system for automatically creating and maintaining a database of information utilizing user knowledge about sales related subjects. Described is an Internet-based system for assisting/motivating a population of users interested in information about certain categories of sales related subjects to automatically maintain the database content and to improve the usefulness and quality of the database information without any substantial management by the website owner-manager. The user opinions are primarily in the form of both comments and ratings of which sales-related subjects best provide assistance in completing a sale. Also a system for permitting users to access selected functions of the system for creating and viewing subjects from within other software applications.

### CROSS-REFERENCE TO RELATED APPLICATION

The present application is related to and claims priority from prior provisional Application Ser. No. 60/504,306 filed Sep. 17, 2003, entitled “SALES ADVICE CONTENT GENERATION SYSTEM”; and is related to application Ser. No. 09/782,873, filed Feb. 10, 2001, entitled “SYSTEM FOR CREATING AND MAINTAINING A DATABASE OF INFORMATION UTILIZING USER OPINIONS”; and is related to application Ser. No. 10/624,345, filed Jul. 22, 2003, entitled “SYSTEM FOR CREATING AND MAINTAINING A DATABASE OF INFORMATION UTILIZING USER OPINIONS”; the contents of all of which are incorporated herein by this reference and are not admitted to be prior art with respect to the present invention by the mention in this cross-reference section.

### BACKGROUND

This invention relates generally to systems for creating, maintaining and using database information. More particularly, it relates to a system for automatically creating and maintaining a database of information utilizing user opinions experiences and knowledge. Even more particularly, it relates to an Internet system related to assisting a population of users to automatically maintain the database content and to improve the usefulness and quality of the database information with no substantial direct, day-to-day management by the website owner-manager.

As the popularity of the Internet and the World Wide Web and therefore, web-based systems has continued to increase over the years, corporations continue to find ways to provide useful content and to promote their products and services in a cost-effective manner and to get consumers to visit their Web sites. Additionally, the value of this method of providing useful content to internal users has also become important for corporations. To that end, corporate on-line services often offer subject search services to their users. These prior systems present a number of limitations and drawbacks for the internal user of the system. Specifically, a user cannot search for a subject based on opinions or ratings of the users of the system. Instead, the search logic is either hierarchical, based on predefined classifications, such as geography, or text based using a search for ambiguous words or phrases contained in the subject's title or description. Users' opinions and ratings are normally not finely detailed or measurable and are separate and unrelated and are not included in the search processes offered to users. Therefore a user is often unable to search for a subject based entirely or partially on the users' opinions or ratings.

Although corporate on-line information services allow users to personalize or customize the information displayed to them on initial entry to the site, such personalization is limited because it does not allow for consideration of the user's interests and related opinions and ratings of the other users. Rather, the personalization is based on personal preferences in specific, and often rigid, categories of information defined based on the search indexes of the database. As a result, information is presented across a spectrum of subjects that are of interest, but without regard to a user's individual needs.

From the perspective of the user, the above-described model presents a number of drawbacks. First, highly structured hierarchical search rules force users to search in predetermined ways, and text-based searches rely on ambiguous words or phrases and focus on names or subjects, not concise descriptions and user's evaluations, making identification and selection of the most relevant content (to a particular searcher) difficult. Second, because searches are either very rigid or very loosely structured, it is difficult for users to compare similar subjects across the spectrum of their needs. Finally, the quality, freshness and completeness of the database of information are often questionable due to a lack of effective methods for soliciting updates and new subject matter. The costs of maintaining the quality and currency of the information through centralized administration can be quite high.

Corporate on-line shared information services also present difficulties for the system operators and managers. Specifically, they require a high degree of human intervention to maintain. Corporate on-line information services permit users to comment on and rate subjects within their site and routinely remove those that are out of date or inappropriate either manually or by automated means based on the age of the comment or rating. However, the current methods lack precision because of the ambiguous nature of the ratings and comments. The ambiguity requires a high level of human intervention if the information is to remain current and appropriate.

Corporate on-line information services sometimes use groups or “populations” or “communities” of contributors, i.e., a population of users, to input and maintain the subject content of the database. These communities may be organized geographically, by functional area, or by subject matter expertise. Often, these communities require significant effort and human intervention to manage. To minimize costs and effort corporate on-line information service, providers often accept content from users and contributors with little or no review before it is posted. Currently, substantial effort is required to manage reviews done by humans and are usually completed by a limited group who are subject matter experts or geographically close to the submitter.

Moreover, prior on-line information systems include incentive systems that have drawbacks. Corporate on-line information services may provide incentives in a variety of forms to encourage contributors to input and maintain subject content. Incentives may also be offered to usage of the service. Users' behavior is little influenced by the incentives except when attempting to “game” the system and gain unfair or improper rewards.

Additionally, these same shortcomings and challenges also face corporations attempting to gather, store and provide internal experience-based information rather than traditional factual information (such as sales numbers, accounting data or contract dates). In fact, a great deal of informal knowledge, based on experiences, which is similar to opinions, exists in many workplace environments. This type of knowledge is very much word-of-mouth based and often very valuable, but not well dispersed through particular groups within the workplace. These challenges exist particularly within sales organizations, which are often large and geographically dispersed. This informal knowledge often consists of information such as which sales techniques work and which do not, which products compete best, what the competition is doing, the primary contacts at a company and who is most knowledgeable about a product or other aspect of selling. This information is typically known by many salespersons and by sales management and product management personnel. Unfortunately, much of this informal knowledge is not available in an organized and usable form to all the sales, sales support and product support people. This knowledge is created as people go about their daily routines, but generally they do not have the tools for easily capturing and classifying it. Similarly, those sales people who need this knowledge do not always know the best sources for it. Frequently, this “real-world” generated knowledge is referred to as “intellectual capital” because it is usually learned through experience and shared informally. “Intellectual capital” is often defined as information known by individuals within the organization that is not necessarily taught, but rather learned through experience. In most cases, “intellectual capital” is highly transitory since it is learned, generally not reduced to writing and usually informally shared. As a result, once a person is no longer associated with the organization, that person's knowledge is also no longer available. This “intellectual capital” clearly represents a form of capital, crucial to a company's success, which is not readily available to all the people equally. As a result, sales persons lacking this knowledge may be hampered in their performance. Additionally, the informality of the sharing also tends to reduce the accuracy of the knowledge as it is shared among co-workers. Many of the automated sales management systems available today capture the data and information about sales activities such as units sold, total sales value, etc., but do not provide a mechanism for capturing, organizing and sharing “intellectual capital”.

Additionally, initial capture of this “intellectual capital” is sometimes difficult to guide and direct even with training. General incentives and awards programs are helpful in generating overall enthusiasm and participation but cannot influence very precisely the nature and types of information captured. To be effective, the “intellectual capital” that is available must conform closely to the needs of the company and its sales staff.

Additionally, corporate users often perceive switching from one computer application to another as a barrier and an inconvenience, particularly if the user must wait while an application “starts up”. This issue often makes it difficult for the user to “capture the moment of inspiration or recollection” while they are working on other tasks. Methods which avoid this barrier and encourage and simplify how users “capture the moment of inspiration or recollection” are limited.

Therefore, there exists a need in the art for an improved system for creating, managing and searching information databases for assisting a population of users.

### OBJECTS OF THE INVENTION

Accordingly, it is an object and feature of this invention to provide such a system to develop and maintain content in a database of subjects (e.g., a product, a service, a leisure activity, an experience or a topic), which content can be easily and uniquely searched by users to help them make informed decisions about the database subjects that are particularly relevant to their needs and desires. It is another object and feature of this invention to provide a system for collecting user opinions and/or reviews regarding the database subjects and for utilizing the user opinions and/or reviews to support database searches and more informed decision-making about the subjects.

Yet another object and feature of the invention is to enable people with diverse backgrounds and qualifications to contribute content to the database and to express opinions or reviews in the form of ratings of database subjects, all in a way that improves the usefulness and quality of the information being added or rated. It is still another object and feature of the invention to reduce the need for centralized control and management of the database content and the contributor community by leveraging the talents, skills, and efforts of the user community to maintain the quality of the database content and the performance of the contributors. It is another object and feature of the present invention to provide a system for encouraging people to create, maintain and provide opinions on the database content.

Yet another object and feature of the invention is to attract users and develop user loyalty through personal involvement and content contribution by way of participation in the rewards of the success of the web site. It is another object and feature of the present invention to provide a system to compensate contributors for their efforts in a manner that will ensure a dynamic, comprehensive and accurate database of information for use by users of the information. It is still another object and feature of the present invention to provide a method and system that motivates contributors to perform highly specific actions that will further the business objectives of the manager of the database.

Another primary object and feature of the present invention is to provide a system for capturing and sharing acquired “intellectual capital” within an organization. It is another object and feature of the present invention to be particularly tailored to capture and share “intellectual capital” particularly for sales.

Still further, it is an object and feature of the present invention to provide such a system to increase and improve the effectiveness of individuals and organizations that employ it through effective capture, sharing and constant refreshing of acquired intellectual capital. It is another object and feature of the present invention to realize significant profitability benefits through structured sharing, collection and automated maintenance of an organization's intellectual capital.

Yet another primary object and feature of the present invention is to provide such a system that is designed to capture, maintain and classify “intellectual capital” in a manner that can be easily understood and used by all users of the organization. The system facilitates categorization of the information and manages the information through automated processes requiring very little human intervention to effectively manage vast quantities of information.

Another primary object and feature of the present invention is to provide a means for accessing the various functions of the present invention from within other software operating on the user's personal computer, laptop, or personal digital assistant

Additional objects, features, and advantages of the invention will be set forth in the description that follows and in part will be apparent from the description or may be learned by practice of the invention. The objects, features and advantages of the invention may be realized and obtained by means of the instrumentalities and combinations pointed out in the appended claims.

### SUMMARY OF THE INVENTION

In accordance with a preferred embodiment hereof, this invention provides an Internet client-server system, relating to assisting a group of users with at least one common goal to capture and search, in at least one database, offered knowledge, relevant to such at least one common goal, of a plurality of such users for the benefit of at least one of such users, comprising: computer interface means for individually capturing at least one experience of at least some of such plurality of such users; computer database means for storing such captured at least one experience associated with at least one of a plurality of kinds of experience; computer interface means for user-searching to select at least one desired kind of such stored at least one experience; computer processor means for performing such user-searching; computer interface means for presenting search results of such performed user-searching; computer processor means for automatically selecting, relating to at least one request formulated to request specified knowledge about at least one of such plurality of kinds of experience, at least one user of such plurality of users to receive such at least one request for such specified knowledge; computer processor means for automatically sending such at least one request for such specified knowledge to such at least one user; computer processor means for receiving at least one reply from such at least one user to such at least one request for such specified knowledge; and computer processor means for adding such received specified knowledge to such at least one database.

In accordance with another preferred embodiment hereof, this invention provides an Internet client-server system relating to assisting a group of users with at least one common goal to capture and search, in at least one database, offered knowledge, relevant to such at least one common goal, of a plurality of such users for the benefit of at least one of such users, comprising: computer interface means for individually capturing at least one experience of at least some of such plurality of such users; computer database means for storing such captured at least one experience associated with at least one of a plurality of kinds of experience; computer interface means for user-searching to select at least one desired kind of such stored at least one experience; computer processor means for performing such user-searching; computer interface means for presenting search results of such performed user-searching; and computer integration means for providing from within at least one other computer-based system at least one first button for accessing such interface means for user-searching to select at least one desired kind of such stored at least one experience. Moreover, it provides such a Internet client-server system further comprising: computer integration means for providing from within such at least one other computer-based system at least one second button for accessing such computer interface means for individually capturing at least one experience of at least some of such plurality of such users; and computer integration means for providing from within such at least one other computer-based system at least one third button for accessing computer interface means for formulating at least one request for such specified knowledge. Additionally, it provides such a Internet client-server system further comprising: computer integration means for providing from within such at least one other computer-based system at least one other button for accessing computer interface means for approving such at least one stored experience; computer integration means for providing from within such at least one other computer-based system at least one additional other button for accessing computer interface means for responding to such at least one formulated request for such specified knowledge; computer integration means for providing from within such at least one other computer-based system at least one yet additional other button for accessing computer interface means for displaying at least one web page of such Internet client-server system. Also, it provides such a Internet client-server system wherein such at least one other computer-based system comprises at least one computer-based email system. In addition, it provides such a Internet client-server system wherein such at least one other computer-based system comprises at least one computer-based word processing system. And, it provides such a Internet client-server system wherein such at least one other computer-based system comprises at least one computer-based spreadsheet system. Further, it provides such a Internet client-server system wherein such at least one other computer-based system comprises at least one computer-based presentation preparation system. Even further, it provides such a Internet client-server system wherein such at least one other computer-based system is manufactured by Microsoft Corporation. Moreover, it provides such a Internet client-server system further comprising: computer processor means for automatically selecting, for at least one request formulated for such specified knowledge about at least one of such plurality of topics, at least one user of such plurality of selected users to receive such at least one request for such specified knowledge; computer processor means for automatically sending such at least one request for such specified knowledge to such at least one user; computer processor means for receiving at least one reply from such at least one user to such at least one request for such specified knowledge; and computer processor means for adding such received specified knowledge to such at least one database.

In accordance with another preferred embodiment hereof, this invention provides an Internet client-server program, relating to assisting at least one group of users having at I east one common goal to capture and search, in at least one database, offered knowledge, relevant to such at least one common goal, of a plurality of such users for the benefit of at least one of such users, comprising the steps of: individually capturing for such at least one database at least one experience of at least some of such plurality; storing in such at least one database such experience; user-searching to select at least one desired kind of stored experience; performing such user-searching; and presenting search results; wherein such at least one database may be initially and continuously seeded by the steps of formulating at least one request for such knowledge relevant to such at least one common goal, automatically selecting at least one user of such group of users to receive such at least one request for such relevant knowledge, automatically sending such at least one request for such relevant knowledge to such at least one user, receiving at least one reply from such at least one user to such at least one request for such relevant knowledge, and adding such received relevant knowledge to such at least one database.

In accordance with another preferred embodiment hereof, this invention provides an Internet client-server program, relating to assisting at least one group of users having at least one common goal to capture and search, in at least one database, offered knowledge, relevant to such at least one common goal, of a plurality of such users for the benefit of at least one of such users, comprising the steps of: individually capturing for such at least one database at least one experience of at least some of such plurality; storing in such at least one database such experience; user-searching, using at least one natural-language word, to select at least one desired kind of stored experience; performing such user-searching; presenting search results; and providing from within at least one other computer-based system at least one first button for user-searching to select at least one desired kind of stored experience. Additionally, it provides such a Internet client-server program further comprising the steps of: providing from within such at least one other computer-based system at least one second button for individually capturing for such at least one database at least one experience of at least some of such plurality; and providing from within such at least one other computer-based system at least one third button for formulating at least one request for such specified knowledge. Also, it provides such a Internet client-server program further comprising the steps of: providing from within at least one other computer-based system at least one other button for approving such at least one stored experience; providing from within at least one other computer-based system at least one additional other button for responding to such at least one formulated request for such specified knowledge; providing from within at least one other computer-based system at least one yet additional other button for displaying at least one web page of such Internet client-server system. In addition, it provides such a Internet client-server program wherein such at least one other computer-based system comprises at least one computer-based email system. And, it provides such a Internet client-server program wherein such at least one other computer-based system comprises at least one computer-based word processing system. Further, it provides such a Internet client-server program wherein such at least one other computer-based system comprises at least one computer-based spreadsheet system. Even further, it provides such a Internet client-server program wherein such at least one other computer-based system comprises at least one computer-based presentation preparation system. Moreover, it provides such a Internet client-server program wherein such at least one other computer-based system is manufactured by Microsoft Corporation. Additionally, it provides such a Internet client-server program further comprising the steps of: initially and continuously seeding such at least one database; wherein such step of initially and continuously seeding such at least one database comprises the steps of formulating at least one request for such knowledge relevant to such at least one common goal, automatically selecting at least one user of such group of users to receive such at least one request for such relevant knowledge, automatically sending such at least one request for such relevant knowledge to such at least one user, receiving at least one reply from such at least one user to such at least one request for such relevant knowledge, and adding such received relevant knowledge to such at least one database.

In accordance with another preferred embodiment hereof, this invention provides a business system, for a developer, relating to use by customers having websites, of web computer systems of the type involving supporting a community of users interacting with at least one database to search for particular subject information, comprising the steps of: providing such computer systems to comprise software management systems to directly manage such at least one database and such community of users essentially without customer website management; and providing variables in such software management systems to be configurable by such customer without affecting such direct management operations; wherein such software management systems comprise automatically measuring efforts of each user of such community, automatically setting of goals for each user of such community, and automatically managing at least one reward system to reward management efforts of each user of such community; wherein such at least one database may be initially and continuously seeded by the steps of formulating at least one request for such particular subject information; automatically selecting at least one such user to receive such at least one request for such particular subject information; automatically sending such at least one request for such particular subject information to such at least one user; receiving at least one reply from such at least one user to such at least one request for such particular subject information; and adding such received particular subject information to such at least one database.

In accordance with another preferred embodiment hereof, this invention provides a business system, for a developer, relating to use by customers having websites, of web computer systems of the type involving supporting a community of users interacting with at least one database to search for particular subject information, comprising the steps of: providing for such computer systems to comprise software management systems to directly manage such at least one database and such community of users essentially without customer website management; providing for variables in such software management systems to be configurable by such customer without affecting such direct management operations; and providing from within at least one other computer-based system at least one first button to so search for such particular subject information; and wherein such software management systems comprise automatically measuring efforts of each user of such community, automatically setting of goals for each user of such community, and automatically managing at least one reward system to reward management efforts of each user of such community. Also, it provides such a business system further comprising: providing from within such at least one other computer-based system at least one second button to individually capture for such at least one database at least one such particular subject information; and providing from within such at least one other computer-based system at least one third button for formulating at least one user request for at least one such particular subject information. In addition, it provides such a business system further comprising: providing from within such at least one other computer-based system at least one other button for approving at least one such particular subject information; providing from within such at least one other computer-based system at least one additional other button for responding to such at least one request for such particular subject information; and providing from within such at least one other computer-based system at least one yet additional other button for displaying at least one web page of such web computer system. And, it provides such a business system wherein such at least one other computer-based system comprises at least one computer-based email system. Further, it provides such a business system wherein such at least one other computer-based system comprises at least one computer-based word processing system. Even further, it provides such a business system wherein such at least one other computer-based system comprises at least one computer-based spreadsheet system. Moreover, it provides such a business system wherein such at least one other computer-based system comprises at least one computer-based presentation preparation system. Additionally, it provides such a business system wherein such at least one other computer-based system is manufactured by Microsoft Corporation. Also, it provides such a business system wherein such at least one database may be initially and continuously seeded by the steps of: formulating at least one request for such particular subject information; automatically selecting at least one such user to receive such at least one request for such particular subject information; automatically sending such at least one request for such particular subject information to such at least one user; receiving at least one reply from such at least one user to such at least one request for such particular subject information; and adding such received particular subject information to such at least one database.

In accordance with another preferred embodiment hereof, this invention provides a business system, supplied by a developer, relating to use by customers having websites comprising web server computer systems of the type involving supporting a community of users, having client computer systems, interacting with at least one database to search for particular subject information, comprising providing, for website use: computer software means for direct automatic management of such at least one database and such community of users essentially without customer website management; and computer software means for permitting such customer to configure a large set of variables in such computer software means for direct automatic management of such at least one database and such community of users without affecting full operation of such direct automatic management; wherein such computer software means for direct automatic management of such at least one database and such community of users essentially without customer website management comprises computer software means for automatically measuring efforts of each user of such community, computer software means for automatic setting of goals for each user of such community, and computer software means for automatically managing a reward system to reward efforts of each user of such community; and computer software means for formulating at least one request for such particular subject information, automatically selecting at least one such user to receive such at least one request for such particular subject information, automatically sending such at least one request for such particular subject information to such at least one user, receiving at least one reply from such at least one user to such at least one request for such particular subject information, and adding such received particular subject information to such at least one database.

In accordance with another preferred embodiment hereof, this invention provides a business system, supplied by a developer, relating to use by customers having websites comprising web server computer systems of the type involving supporting a community of users, having client computer systems, interacting with at least one database to search for particular subject information, comprising providing, for website use: computer software means for direct automatic management of such at least one database and such community of users essentially without customer website management; and computer software means for permitting such customer to configure a large set of variables in such computer software means for direct automatic management of such at least one database and such community of users without affecting full operation of such direct automatic management; wherein such computer software means for direct automatic management of such at least one database and such community of users essentially without customer website management comprises computer software means for automatically measuring efforts of each user of such community, computer software means for automatic setting of goals for each user of such community, and computer software means for automatically managing a reward system to reward efforts of each user of such community; and computer integration means for providing from within at least one other computer-based system at least one first button for accessing at least one such client computer system to so search for such particular subject information. In addition, it provides such a business system further comprising: computer integration means for providing from within such at least one other computer-based system at least one second button to individually capture for such at least one database at least one such particular subject information; and computer integration means for providing from within such at least one other computer-based system at least one third button for formulating at least one user request for at least one such particular subject information. And, it provides such a business system further comprising: computer integration means for providing from within such at least one other computer-based system at least one other button for approving at least one such particular subject information; computer integration means for providing from within such at least one other computer-based system at least one additional other button for responding to such at least one request for such particular subject information; and computer integration means for providing from within such at least one other computer-based system at least one yet additional other button for displaying at least one web page of such web computer system. Further, it provides such a business system wherein such at least one other computer-based system comprises at least one computer-based email system. Even further, it provides such a business system wherein such at least one other computer-based system comprises at least one computer-based word processing system. Moreover, it provides such a business system wherein such at least one other computer-based system comprises at least one computer-based spreadsheet system. Additionally, it provides such a business system wherein such at least one other computer-based system comprises at least one computer-based presentation preparation system. Also, it provides such a business system wherein such at least one other computer-based system is manufactured by Microsoft Corporation.

In accordance with another preferred embodiment hereof, this invention provides a business system, supplied by a developer, relating to use by customers having websites comprising web server computer systems of the type involving supporting a community of users, having client computer systems, interacting with at least one database searching for particular subject information, comprising providing, for website use: computer software means for direct automatic management of such at least one database and such community of users essentially without customer website management; computer software means for permitting such customer to configure a large set of variables in such computer software means for direct automatic management of such at least one database and such community of users without affecting full operation of such direct automatic management; wherein such computer software means for direct automatic management of such at least one database and such community of users essentially without customer website management comprises computer software means for automatically measuring efforts of each user of such community, computer software means for automatic setting of goals for each user of such community, and computer software means for automatically managing a reward system to reward efforts of each user of such community; computer processor means for formulating at least one request for such particular subject information, automatically selecting at least one such user to receive such at least one request for such particular subject information, automatically sending such at least one request for such particular subject information to such at least one user, receiving at least one reply from such at least one user to such at least one request for such particular subject information, and adding such received particular subject information to such at least one database; and computer integration means for providing from within at least one other computer-based system at least one first button for accessing at least one such client computer system to so search for such particular subject information.

In accordance with another preferred embodiment hereof, this invention provides a computer system, relating to assisting automatic request and receipt of specified information about at least one plurality of topics from at least one plurality of selected users to create at least one database of such information and to improve the usefulness and quality of such at least one database without substantial management, comprising the steps of: formulating at least one request for such specified information about at least one of such plurality of topics; automatically selecting at least one user of such plurality of selected users to receive such at least one request for such specified information; automatically sending such at least one request for such specified information to such at least one user; receiving at least one reply from such at least one user to such at least one request for such specified information; and adding such received specified information to such at least one database. In addition, it provides such a computer system, wherein the step of formulating at least one request for such specified information about at least one of such plurality of topics comprises the steps of: identifying at least one topic for which such specified information is to be requested; formulating such at least one request for such specified information about at least one of such plurality of topics; assigning at least one priority to each such at least one request; and assigning each such at least one request to at least one primary topic. And, it provides such a computer system, wherein the step of automatically sending such at least one request for such specified information to such at least one user comprises the steps of: setting the daily maximum number of such requests to be sent to such at least one user; specifying the timeframe for re-sending each such at least one request to such at least one user; selecting each such at least one user to receive such at least one request; sending such at least one request to such at least one user; recording content of such at least one request and delivery information for such at least one user; and adding at least one transmittal record, which includes at least one identifier of such at least one request, of delivery information for such at least one user and date and time of transmission, to such at least one database. Further, it provides such a computer system, wherein the step of sending such at least one request to such at least one user comprises the steps of: identifying such plurality of users with known expertise in such primary topic of such at least one request; for each such at least one request, referring to the latest such at least one transmittal record for each identified at least one user and such at least one request combination; selecting only those users who have not received such request within the defined timeframe; limiting the number of such requests sent daily to each of such selected users knowledgeable about such at least one of such plurality of topics; limiting the number of such selected users which may receive such at least one request to a daily maximum percentage of all possible such selected users; and sending such at least one request to selected at least one user who has not received such at least one request within such specified timeframe for each such at least one request. Even further, it provides such a computer system, wherein the step of adding such received specified information to such at least one database comprises the steps of: adding at least one receipt record, which includes at least one identifier of such at least one request, reply information for such at least one user and date and time of receipt of, to such at least one database; approval of such at least one reply information by such at least one authorized user; adding such at least one reply information to such at least one database. Moreover, it provides such a computer system wherein the specified information about the at least one plurality of topics comprises at least one rating of at least one reply of at least one other user. Additionally, it provides such a computer system wherein such at least one selected user comprises a person knowledgeable about such at least one selected topic.

In accordance with another preferred embodiment hereof, this invention provides a computer system, relating to assisting automatic request and receipt of specified information about at least one plurality of topics from at least one plurality of selected users to create at least one database of such information and to improve the usefulness and quality of such at least one database without substantial management: processor means for automatically selecting, for at least one request formulated for such specified information about at least one of such plurality of topics, at least one user of such plurality of selected users to receive such at least one request for such specified information; processor means for automatically sending such at least one request for such specified information to such at least one user; processor means for receiving at least one reply from such at least one user to such at least one request for such specified information; and processor means for adding such received specified information to such at least one database. Also, it provides such a computer system, wherein such processor means for automatically selecting, for at least one request formulated for such specified information about at least one of such plurality of topics, at least one user of such plurality of selected users to receive such at least one request for such specified information comprises: processor means for identifying at least one topic for which such specified information is to be requested; computer input means for assisting formulating such at least one request for such specified information about at least one of such plurality of topics; computer input means for assisting assigning at least one priority to each such at least one request; computer input means for assisting assigning each such at least one request to at least one primary topic; and processor means for automatically selecting at least one user of such plurality of selected users to receive such at least one request for such specified information. In addition, it provides such a computer system, wherein such processor means for automatically sending such at least one request for such specified information to such at least one user comprises: computer input means for assisting setting the daily maximum number of such requests to be sent such to at least one user; computer input means for assisting specifying the timeframe for re-sending each such at least one request to such at least one user; processor means for selecting each such at least one user to receive such at least one request; processor means for sending such at least one request to such at least one user; processor means for recording content of such at least one request and delivery information for such at least one user; and processor means adding at least one transmittal record, which includes at least one identifier of such at least one request, of delivery information for such at least one user and date and time of transmission, to such at least one database. And, it provides such a computer system, wherein such processor means for sending such at least one request to such at least one user comprises: processor means for identifying such plurality of users with known expertise in such primary topic of such at least one request; for each such at least one request, processor means for referring to the latest such at least one transmittal record for each identified at least one user and such at least one request combination; processor means for selecting only those users who have not received such request within the defined timeframe; processor means for limiting the number of such requests sent daily to each of such selected users knowledgeable about such at least one of such plurality of topics; processor means for limiting the number of such selected users which may receive such at least one request to a daily maximum percentage of all possible such selected users; and processor means for sending such at least one request to selected at least one user who has not received such at least one request within such specified timeframe for each such at least one request. Further, it provides such a computer system, wherein such processor means for adding such received specified information to such at least one database comprises: processor means for adding at least one receipt record, which includes at least one identifier of such at least one request, reply information for such at least one user and date and time of receipt of, to such at least one database; processor means for approval of such at least one reply information by such at least one authorized user; and processor means for adding such at least one reply information to such at least one database. Even further, it provides such a computer system wherein the specified information about the at least one plurality of topics comprises at least one rating of at least one reply of at least one other user. Moreover, it provides such a computer system wherein such at least one selected user comprises a person knowledgeable about such at least one selected topic.

In accordance with a preferred embodiment hereof, this invention provides a computer method relating to automatically transferring displayed information between computer programs comprising the steps of: establishing at least one inter-program link between at least one first computer program and at least one second computer program; starting such at least one first computer program; highlighting information within at least one first display area controlled by such at least one first program; accessing such at least one second computer program using such at least one inter-program link; and automatically transferring such highlighted information to at least one second display area controlled by such at least one second computer program.

### Glossary of General Terms and Acronyms

The following terms and acronyms explained below as background and are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web, the client is typically a “Web browser” which runs on a user's computer; the program which responds to Web browser requests at a Web site is commonly referred to as a “Web server.”

Domain Name System (DNS). An Internet service that translates domain names (which are alphabetic identifiers) into IP addresses (which are numeric identifiers for machines on a TCP/IP network).

Experience. This term is used interchangeably with the term “subject” and is intended to have the same definition.

HyperText Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471-11894-4).

HyperText Transport Protocol (HTTP). The standard World Wide Web client-server protocol used for the exchange of information (such as HTML documents, and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

Internet. A collection of interconnected (public and/or private) networks that are linked together by a set of standard protocols to form a distributed network. While this term is intended to refer to what is now commonly known as the Internet, it is also intended to encompass variations which may be made in the future, including changes and additions to existing standard protocols.

Internet Information Server (IIS). Microsoft Corporation's Web server that runs on Windows NT platforms.

Java. A general purpose programming language developed by Sun Microsystems. Java has a number of features that make the language well-suited for use on the World Wide Web. Small Java applications are called Java applets and can be downloaded from a Web server and run on a personal computer by a Java-compatible Web browser, such as Netscape Navigator or Microsoft Explorer.

Java Servlets. A small Java-based program designed to perform a specific task within a Web server environment. Java Servlets are analogous to Java applets except they are designed to only run on the Web server.

Java Virtual Machine. A set of applications that create a run time environment for executing Java code.

JRun. A server-side extension that allows a Web server to execute Java Servlets for the processing and display of information. JRun is a widely adopted engine for developing and deploying server-side Java applications that use Java Servlets and JavaServer Pages (JSP).

Java Database Connectivity (JDBC). A Java API developed by JavaSoft, a subsidiary of Sun Microsystems of Mountain View, Calif. JDBC enables Java programs to execute SQL statements, which allows Java programs to interact with any SQL-compliant database. Since many relational database management systems (RDBMS's) support SQL, and because Java itself runs on most platforms, JDBC makes it possible to write a single database application that can run on different platforms and interact with different database management systems. JDBC is similar to ODBC but is designed specifically for Java programs, whereas ODBC is language-independent.

Open DataBase Connectivity (ODBC). A database access method developed by Microsoft Corporation. ODBC allows an application to access data from a database by translating the application's data queries into commands that the database management system (DBMS) can understand.

Subject. The information content that describes a topic/product/service about which the advice is being given or sought.

Transmission Control Protocol/Internet Protocol (TCP/IP). A standard Internet protocol (or set of protocols) which specifies how two computers exchange data over the Internet. TCP/IP handles issues such as packetization, packet addressing, handshaking and error correction. For more information on TCP/IP, see Volumes I, II and III of Corner and Stevens, Internetworking with TCP/IP, Prentice Hall, Inc., ISBNs 0-13-468505-9 (vol. 1), 0-13-125627-4 (vol. 11), and 0-13-474222-2 (vol. III).

Uniform Resource Locator (URL). A unique address which fully specifies the location of a file or other resource on the Internet. The general format of a URL is protocol://machine address:port/path/filename. The port specification is optional, and if none is entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

User. Term used to refer to either guests or contributors, or both, where no distinction of role is required.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the HyperText Transfer Protocol (HTTP), and the electronic pages are encoded using the HyperText Markup Language (HTML). However, the terms “World Wide Web” and “Web” are intended to encompass future markup languages and transport protocols which may be used in place of or in addition to the HyperText Markup Language and the HyperText Transfer Protocol.

### BRIEF DESCRIPTION OF THE DRAWINGS

FIG. 1 is diagrammatical overview of the Internet communications used in the instant system according to a preferred embodiment of the present invention.

FIG. 2 is diagrammatical overview of the website computer system according to a preferred embodiment of the present invention.

FIG. 3 is diagrammatical overview of the relationship among the website servers and the users according to a first preferred embodiment of the present invention.

FIG. 4 is a diagrammatical view of the preferred instant software system according to a preferred embodiment of the present invention.

FIG. 5 is a diagrammatical view of the activity database according to a preferred embodiment of the present invention.

FIG. 6 is a diagrammatical view of the experience management automation according to a preferred embodiment of the present invention.

FIG. 7 is a diagrammatical view of reporting management automation according to a preferred embodiment of the present invention.

FIG. 8 is a diagrammatical view of the user management automation according to a preferred embodiment of the present invention.

FIG. 9 is a diagrammatical view of the awards and contests management automation according to a preferred embodiment of the present invention.

FIG. 10 is a diagrammatical view of the e-mail management automation according to a preferred embodiment of the present invention.

FIG. 11 is a diagrammatical view of a preferred business method according to a preferred embodiment of the present invention.

FIG. 12 is a schematic view of a preferred method of initially and continuously requesting user participation in adding subjects (such as experiences or Sales Advice) to the database according to a preferred embodiment of the present invention.

FIG. 13 is a schematic view of a preferred method of initially and continuously requesting user participation in rating the quality and value of subjects (such as experiences or Sales Advice) in the database according to a preferred embodiment of the present invention.

FIG. 14 is a detail logic diagram of the set up and automation of requesting user participation in adding subjects to the database according to a preferred embodiment of the present invention.

FIG. 15 is a detail logic diagram of the set up and automation of requesting user participation in rating the quality and value of subjects (such as experiences or Sales Advice) in the database according to a preferred embodiment of the present invention.

FIG. 16 is a sample of a preferred login screen for the system according to a preferred embodiment of the present invention.

FIG. 17 is a sample of a preferred home page screen for the system according to a preferred embodiment of the present invention.

FIG. 18 illustrates a sample preferred screen for Mypage of the system according to a preferred embodiment of the present invention.

FIG. 19 provides a sample of the preferred first set up and management screen for the dynamic content generation module of the system according to a preferred embodiment of the present invention.

FIG. 20 provides a sample preferred screen for the adding a new question (request for information) to the database for the dynamic content generation module of the system according to a preferred embodiment of the present invention.

FIG. 21 illustrates a sample preferred screen for inputting or editing the content of an email message requesting information about a topic from a selected user for the dynamic content generation module of the system according to a preferred embodiment of the present invention.

FIG. 22 illustrates the details of an email message requesting information about a topic from a selected user for the dynamic content generation module of the system according to a preferred embodiment of the present invention.

FIG. 23 illustrates a sample of an email, received by a user, requesting information regarding a specific issue as automatically generated by the dynamic content generation module of the system according to a preferred embodiment of the present invention.

FIG. 24 illustrates a sample of an email; received by a user, after response by the user to the request for information regarding a specific issue as automatically generated by the dynamic content generation module of the system according to a preferred embodiment of the present invention.

FIG. 25 provides a sample email automatically generated and sent to a user with approval authority after receipt by the system of response to an email request by a user. This email message is generated by the dynamic content generation module of the system according to a preferred embodiment of the present invention.

FIG. 26 illustrates sample screen display a list of submitted information and rating awaiting approval by an authorized user according to a preferred embodiment of the present invention.

FIG. 27 illustrates the detail review and approval screen utilized by an authorized user to review information submitted by another user which was requested by the dynamic content generation module of the system according to a preferred embodiment of the present invention.

FIG. 28 illustrates confirmation and thank you screen presented to a user after approving information submitted as a result of a request from the dynamic content generation module of the system according to a preferred embodiment of the present invention.

FIG. 29 is a sample screen which presents the listing of all unanswered questions (requests for information) sent to a user by the dynamic content generation module of the system and a summary count of the user's overall status with regard to questions (requests for information) received from the dynamic content generation module of the system according to a preferred embodiment of the present invention.

FIG. 30 illustrates the screens used to respond to an unanswered question (request for information) sent to others by in the user's area of expertise the dynamic content generation module of the system according to a preferred embodiment of the present invention.

FIG. 31 is an example of screen that presents a list of questions (requests for information), sent from the dynamic content generation module of the system to users, which have not been answered. A user may select a question and answer it as if it had been sent to the user according to a preferred embodiment of the present invention.

FIG. 32 is an example of screen which permits authorized users to modify key parameters to automatically control the frequency and quantity of requests sent to selected users according to a preferred embodiment of the present invention.

FIG. 33 is an example of screen that preferably permits authorized users to set the number of question each expert in a functional area of the company may receive each day according to a preferred embodiment of the present invention.

FIG. 34 illustrates an example of the initial screen for setting up toolbar integration with Microsoft Office products according to a preferred embodiment of the present invention.

FIG. 35 illustrates an example of the installation start screen for Microsoft Office toolbar integration according to a preferred embodiment of the present invention.

FIG. 36 illustrates an example of the verify user id and password screen which ensures only authorized users can install Microsoft Office toolbar integration according to a preferred embodiment of the present invention.

FIG. 37 illustrates an example of the Microsoft Outlook Options dialog box which includes an additional tab for the present invention according to a preferred embodiment of the present invention.

FIG. 38 illustrates an example of the options screen for the present invention accessed from within the Microsoft Outlook Options dialog box after installation of the Microsoft Office toolbar integration module according to a preferred embodiment of the present invention.

FIG. 39 illustrates an example of how integration toolbar of the present invention is included within Microsoft Outlook, according to a preferred embodiment of the present invention.

FIG. 40 illustrates an example screen display after the present invention was selected using the “StreetSmarts” text link from the integration toolbar from within Microsoft Outlook, according to a preferred embodiment of the present invention.

FIG. 41 is a diagrammatic representation of the various text links available on the integration toolbar of the present invention, according to a preferred embodiment of the present invention.

FIG. 42 is an example dialog presented to a user after selecting the “Ask Question” text link on the integration toolbar of the present invention, according to a preferred embodiment of the present invention.

FIG. 43 is an example dialog box presented to a user after selecting the “Add Category” button from within the “Ask a Question” dialog box of the present invention which permits a user to complete and submit a question to the other users of the present invention, according to a preferred embodiment of the present invention.

FIG. 44 is an example dialog box presented to a user after selecting the “Add Attachment” button from within the “Ask a Question” dialog box of the present invention permitting a user to add a document as an attachment to a question, according to a preferred embodiment of the present invention.

FIG. 45 is an example dialog box presented to a user after selecting the “Add Link” button from within the “Ask a Question” dialog box of the present invention permitting a user to add an URL address link to a question, according to a preferred embodiment of the present invention.

FIG. 46 is an example Ask a Question dialog box presented to a user after selecting the “Options” button from within the “Ask a Question” dialog box of the present invention permitting a user to select additional options for the current question, according to a preferred embodiment of the present invention.

FIG. 47 illustrates an example dialog box presented to a user after selecting the “Attachments” button from within the “Options” dialog box of the present invention permitting a user to select attachment options for the current question, according to a preferred embodiment of the present invention.

FIG. 48 is an example dialog box presented to a user after selecting the “Recipients” button from within the “Options” dialog box of the present invention permitting a user to select additional individuals and/or functional areas to receive the current question, according to a preferred embodiment of the present invention.

FIG. 49 illustrates an example dialog box presented to a user after selecting the “Address Book” button from within the “Select Recipients” dialog box of the present invention permitting a user to select particular individuals to receive the current question, according to a preferred embodiment of the present invention

FIG. 50 is an example screen display of a completed “Ask a Question” dialog according to a preferred embodiment of the present invention.

FIG. 51 is an example Add Advice dialog presented to a user after selecting the “Add Advice” text link on the integration toolbar of the present invention, according to a preferred embodiment of the present invention.

FIG. 52 illustrates an example dialog box presented to a user after selecting the “Keywords . . . ” button from within the “Add Advice” dialog box of the present invention permitting a user to select particular keywords for association with the current item of advice, according to a preferred embodiment of the present invention

FIG. 53 is an example screen display of a completed “Add Advice” dialog according to a preferred embodiment of the present invention.

FIG. 54 is an example Unanswered Questions Queue dialog presented to a user after selecting the “Questions (n)” text link on the integration toolbar of the present invention, according to a preferred embodiment of the present invention.

FIG. 55 presents an example Unapproved Advice Queue dialog presented to a user after selecting the “Approvals (n)” text link on the integration toolbar of the present invention, according to a preferred embodiment of the present invention

FIG. 56 illustrates the screen display used to review and approve submitted advice according to a preferred embodiment of the present invention.

FIG. 57 illustrates how the integration toolbar of the present invention is presented from within Microsoft Excel, according to a preferred embodiment of the present invention.

FIG. 58 illustrates how the integration toolbar of the present invention is presented from within Microsoft Word, according to a preferred embodiment of the present invention.

FIG. 59 illustrates how the integration toolbar of the present invention is presented from within Microsoft PowerPoint, according to a preferred embodiment of the present invention.

### DETAILED DESCRIPTION OF THE BEST MODES AND PREFERRED EMBODIMENTS OF THE INVENTION

Reference will now be made in more detail to best modes and preferred embodiments of the systems of the invention as illustrated in the accompanying drawings, in which like numerals refer to like parts throughout the several views. In the accompanying drawings, well-known structures and devices are shown in block diagram form in order to provide an understanding of the interrelationship between components and the flow of information and control throughout the depicted preferred embodiment of the present invention. It will be apparent to one skilled in the art from the teachings herein that the invention may be practiced with a variety of different specific components, without detraction or departure from the scope of the present invention, provided to serve the generalized block diagram description. Specific statements made with respect to any of these operations are intended to clarify the nature of the operation being performed, but should not be taken as a limitation of the operation should an alternative operation be desired in a substantially similar situation or setting.

According to a preferred embodiment of the present invention, a method and system (software) is described for creating and maintaining a database of subject material primarily related to sales and sales related activities, knowledge and success stories. Additionally, in a preferred embodiment of the present invention, users are provided the opportunity to search the database and to identify subject matter relevant to the users' needs either through a key word search or category browsing. Additionally, users may preferably search for experts with particular knowledge relevant to their needs. Users may also search for and review success stories. When users cannot find required knowledge they may also submit questions which will be answered by designated individuals with knowledge in the subject matter related to the question. Additionally all questions and related answers are added to the database and become additional subject matter available for search and review.

It is especially noted that, in order to help sell such systems, the developer, in the software system design, should preferably limit the operator's labor of management and other responsibilities. The instant system, in the specific manners described herein, is a preferred embodiment of such a system, needing essentially no operator management—the software itself motivates and rewards the user community sufficiently to keep them doing the sorts of duties otherwise befalling an operator.

In this detailed description, presented first along with some hardware information will be on overall look at the systems of the preferred embodiment and the functional interaction among the parties and the system parts, in conjunction with diagrammatic charts. Then the detailed operation of the preferred embodiment will be presented in conjunction with screen diagrams. The various levels and kinds of descriptions herein are intended to be read in conjunction with each other in understanding the details of the preferred embodiment of the invention.

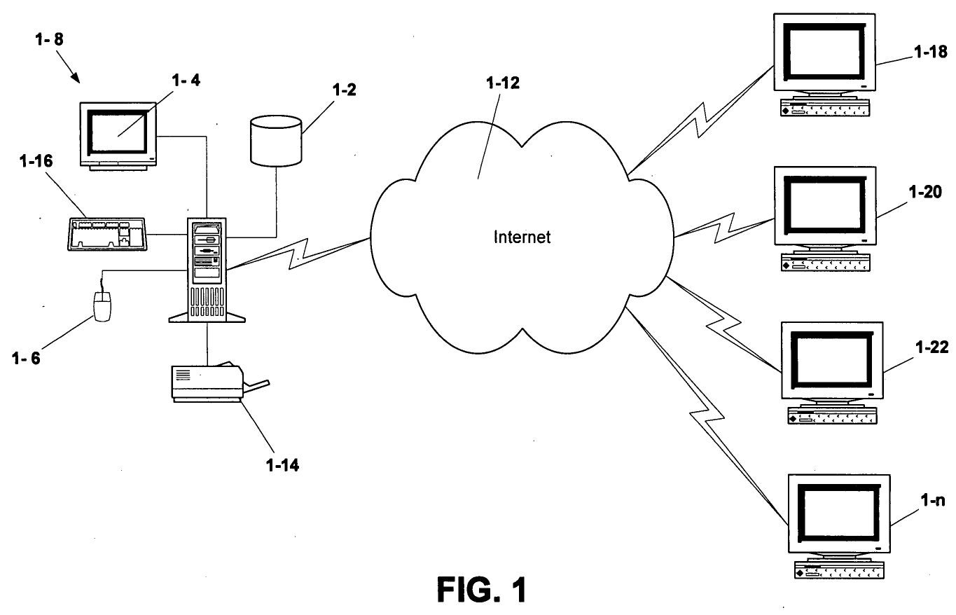

Referring now to FIG. 1, an overview of a preferred embodiment of the present invention is shown. The present invention preferably comprises a computer system 1-8. The computer system 1-8 comprises input and output devices as is well known in the art. For example, the computer system 1-8 preferably comprises a display screen or monitor 1-4, a keyboard 1-16, a printer 1-14, a mouse 1-6, etc. The computer system 1-8 further preferably comprises a database 1-2 for storage of the data and software comprising preferred embodiments of the present invention. The computer system 1-8 is preferably connected to the Internet 1-12 that serves as the presently preferred communications medium. The Internet 1-12, as previously discussed, comprises a global network of networks and computers, public and/or private. The Internet 1-12 is the preferable connection method by the users 1-18, 1-20, 1-22 and 1-n in preferred embodiments of the present invention.

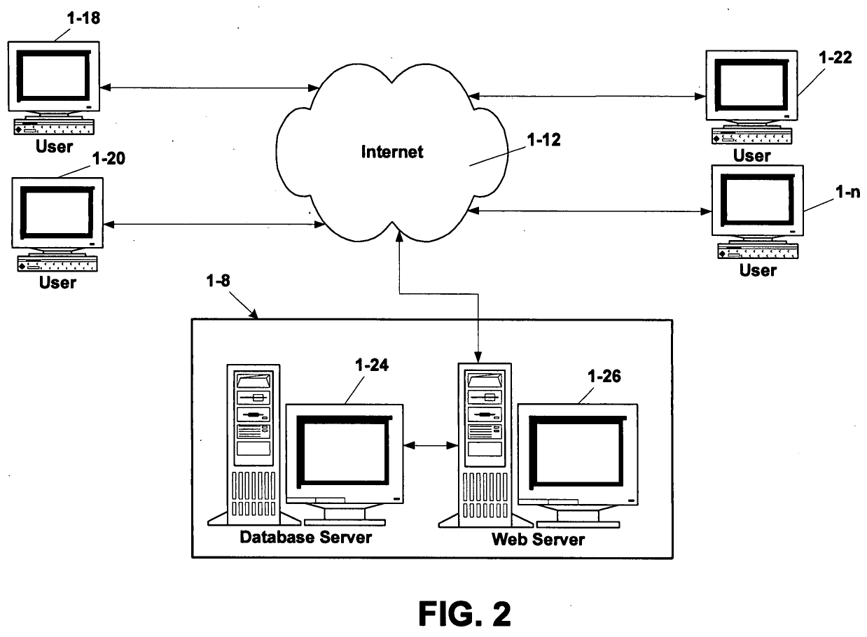

Referring now to FIG. 2, the computer system 1-8 is shown in more detail. The computer system 1-8 in a preferred embodiment comprises a database server 1-24 and a web server 1-26. The database server 1-24 preferably runs in a Windows Server (offered by Microsoft Corporation) operating system environment and preferably utilizes Oracle Database (offered by Oracle Corporation) as the database engine. Upon reading the teachings of this specification, those with ordinary skill in the art will now understand that, under appropriate circumstances, considering such issues as advances in technology, user preference, user location, etc., other database engine products, such as DB2 (offered by IBM Corporation), Microsoft SQL Server offered by (Microsoft Corporation), etc., may suffice. The database server 1-24 preferably processes all background processes and email. Preferably all background processes are written in Java and run as separate execution threads on a pre-set schedule. The web server 1-26 also preferably runs in an operating system environment using Windows Server (offered by Microsoft Corporation). The web server 1-26 operates as the web server and the servlet engine. Preferably the web server software is written in JAVA. Upon reading the teachings of this specification, those with ordinary skill in the art will now understand that, under appropriate circumstances, considering such issues as advances in technology, user preference, user location, etc., other operating systems environments, such as LINUX, etc., may suffice.

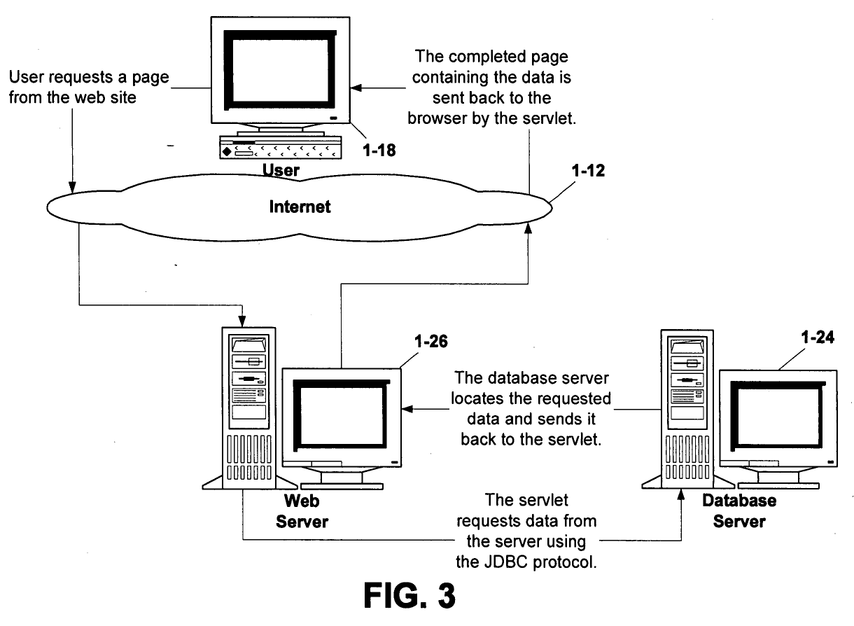

Referring to FIG. 3, a simplified functional diagram of a preferred embodiment of the present invention is shown. This figure shows the preferred relationships between a user 1-18 (as an example of any number of users 1-18, 1-20, 1-22, 1-n), the Internet 1-12, the web server 1-26 and the database server 1-24. As shown, a user 1-18 requests a page from the web site of the present invention operating on the web server 1-26. The user 1-18 is preferably connected via the Internet 1-12, and the web page request initiates a call to a Java servlet housed on the web server 1-26. The Java servlet is run by the JRun engine which makes at least one request to the database server 1-24, the database server 1-24 completes the servlet's request and transmits the requested data back to the web server 1-26. The web server 1-26 then transmits the completed HTML page containing the data requested by the user 1-18 through the Internet 1-12 to the user 1-18.

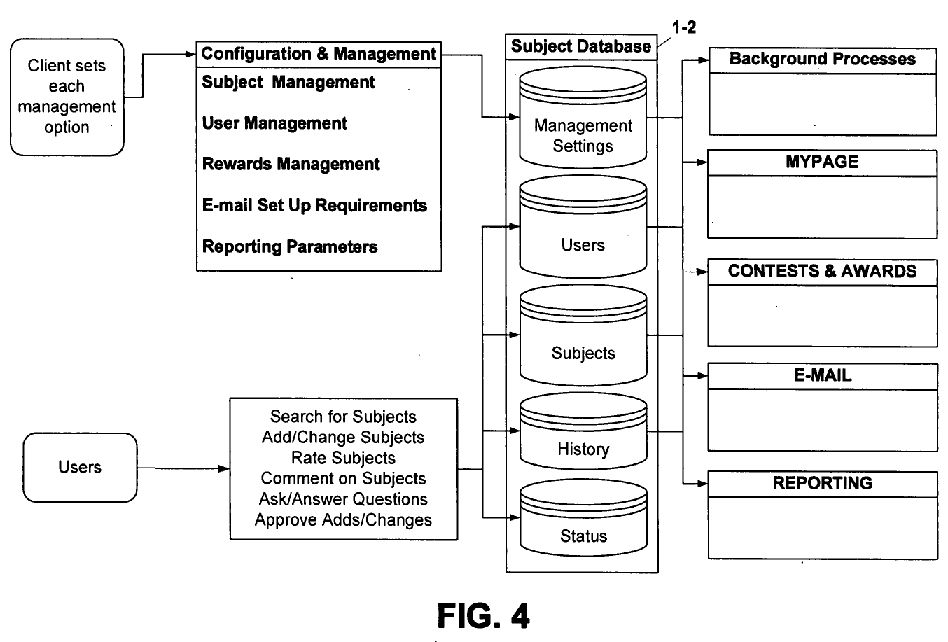

Referring briefly to FIG. 4, a high level functional diagram of the process flows and functions in a preferred embodiment of the present invention is shown. Shown herein is that the client sets each management option preferably using the Configuration and Management Module, used herein refer to the subsystem of the instant overall system used by customers (website owners) to configure the instant system as preferred by such customer (at least embodying herein providing variables in such software management systems to be configurable by such customer without affecting such direct management operations; and computer software means for permitting such customer to configure a large set of variables in such computer software means for direct automatic management of such at least one database and such community of users without affecting full operation of such direct automatic management). The Configuration and Management Module preferably comprises the following modules which will be explained in greater detail herein below: Subject Management, User Management, Rewards Management, E-Mail Set Up Requirements, and Reporting Parameters. The Configuration and Management Modules are coupled to the database tables. The database tables preferably comprise the following modules that will also be explained in greater detail herein below: Management Settings, Users, Subjects, History, and Status. (For more detailed descriptions of the Configuration and Management Modules see U.S. patent application publication No. 20010047290, herein incorporated in total by reference.) Also shown is that the users may perform certain tasks or otherwise exercise functions, preferably comprising: Search for Subjects, View Subjects, Add/Change Subjects, Rate Subjects, Comment on Subjects, Approve Adds/Changes, and Ask/Answer Questions (at least embodying herein computer interface means for individually capturing at least one experience of at least some of such plurality of such users; at least embodying herein individually capturing for such at least one database at least one experience of at least some of such plurality; at least embodying herein computer interface means for user-searching to select at least one desired kind of such stored at least one experience; at least embodying herein user-searching to select at least one desired kind of stored experience; at least embodying herein computer processor means for performing such user-searching; at least embodying herein performing such user-searching; at least embodying herein computer interface means for presenting search results of such performed user-searching; and at least embodying herein performing such user-searching).

Further preferably linked to the Database are the main modules or functions: Background Processes, Mypage, Contests & Awards, E-Mail, and Reporting.

In the preferred embodiment, the database 1-2 includes the following tables:
Domain Tables: These tables contain the required reference information used to ensure accuracy and consistency of the subject content, guest and contributor information. And (see FIG. 4) these tables are preferably part of management settings.
Application Status Tables: These tables contain information necessary to manage user interactions such as the “state” or status of each active guest or contributor. Status information includes, but is not necessarily limited to, information such as user id, the last screen used, current screen in use, and start of the current session. See FIG. 4 under “Status”.
System Tables: These tables contain the parameters required to control the behavior of the system. Information in these tables gives the system to make decisions regarding certain actions. And (see FIG. 4) these tables are part of management automation settings.
User Tables: The user tables contain all data relevant to registered users of the system. Information includes demographic, system role points earned, points goals, personal preferences, book marked subjects of personal interest. See FIG. 4 under “Users”.
Subject Tables: The subject tables contain all information collected about a subject. For example, all data describing the subject, location of the subject, guest ratings, guest comments, etc. are included here (at least embodying herein computer database means for storing such captured at least one experience associated with at least one of a plurality of kinds of experience; and at least embodying herein storing in such at least one database such experience). See FIG. 4 under “Subjects”.
History Tables. The history tables contain all information collected about user activities, page views, etc. See FIG. 4 under “History”.

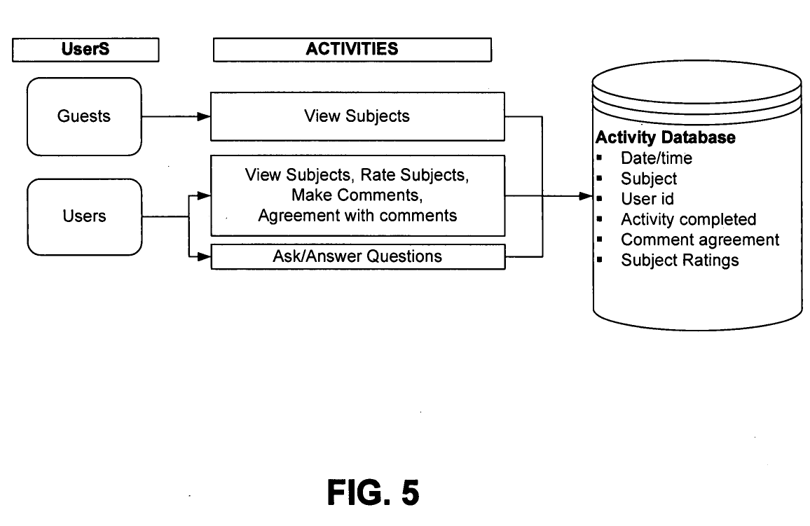

Referring to FIG. 5, an overview functional diagram of the Activity Database of the main Database 1-2 (see FIG. 1 and FIG. 4) is shown. As shown, the Activity Database preferably comprises Activities performed by Users that cause data additions/changes to the Activity Database. The Users comprise: Guests and Users, (also called Contributors herein). The Users may take various actions or interact preferably as follows: Guests may View Subjects. In contrast, Users may View: Subjects, Overall Ratings, and Comments Made, and. Preferably, Users may also: indicate Agreement with comments, rate comments of other users, ask questions of other users, answer questions from other users and may submit Modify Subject Requests, Delete Subject Requests, and Ratings Reset Requests.

Additionally, activities by the Users may preferably be reflected in the Activity Database. The Activity Database fields preferably comprise: Date/time, Subject, User ID, Activity completed, Words & ratings, Comment agreement, and Subject 3rd page viewed fields. Upon reading the teachings of this specification, those with ordinary skill in the art will now understand that, under appropriate circumstances, considering such issues as advances in technology, user preference, user reporting requirements, etc., other Activity Database Fields, such as questions asked count, questions answered count, comments made count, etc., may be included in the Activity Database (at least embodying herein automatically measuring efforts of each user of such community; at least embodying herein computer software means for automatically measuring efforts of each user of such community).

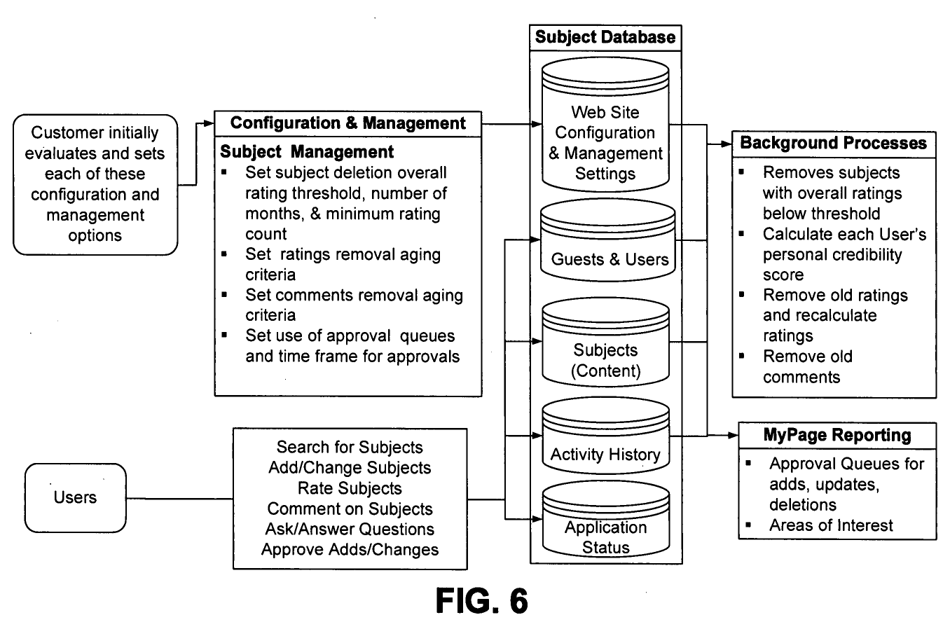

Referring to FIG. 6, a high level functional diagram of the Subject Management Automation software is shown. The core of the Subject Management Automation software is preferably comprised within the Configuration and Management Module. The Configuration and Management Module performs Subject Management that preferably comprises the activities of allowing the Customer to: Set subject deletion overall rating threshold, number of months, and minimum rating count; Set ratings removal aging criteria; and Set use of approval queues and time frame for approvals to move (at least embodying herein providing such computer systems to comprise software management systems to directly manage such at least one database and such community of users essentially without customer website management; at least embodying herein computer software means for direct automatic management of such at least one database and such community of users essentially without customer website management). For each of these activities, the customer preferably initially evaluates and sets each of these configuration and management options that are comprised within the Configuration and Management Module as desired. The Subject Management settings are preferably placed into the Subject Database where they affect and are stored in the Web Site Configuration & Management Settings table. (For more detailed descriptions of the Subject Automation Management software see U.S. patent application publication No. 20010047290, herein incorporated in total by reference.)

Users may interact with the Subject Management Automation software and perform activities that preferably comprise: Search for Subjects, Add/Change Subjects, Rate Subjects, Comment on Subjects, Approve Adds/Changes, Ask Questions of other users, and Answer Questions from other users. These activities affect the Subject Database tables: Users; Subjects (Content); Activity History; and Application Status.

The Subject Database tables' content and/or changes are preferably input to the Background Processes Module which will preferably: Remove subjects with overall ratings below threshold; Calculate each user's personal credibility rating for use in calculating the subject ratings; Remove old ratings and recalculate ratings; and Remove old comments. The Subject Database tables content and/or changes are also preferably input to the Reporting Module which will assist implementation of the working of Approval Queues for subject additions, updates, and deletions.

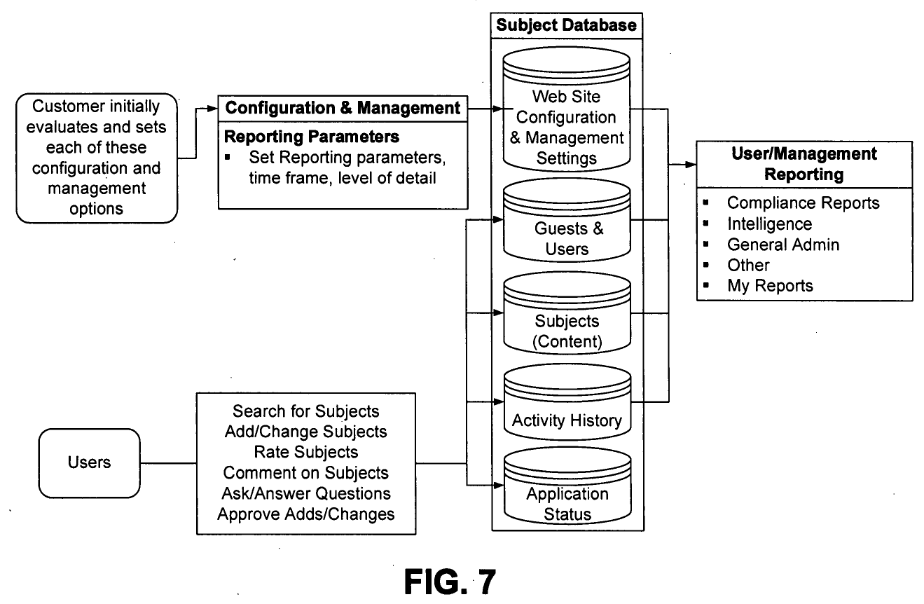

Referring to FIG. 7, a high level functional diagram of the Reporting Management Automation software is shown. The core of the Reporting Management Automation software is preferably comprised within the Configuration and Management Module. The Configuration and Management Module comprises Reporting Parameters that preferably comprises the activity of allowing the Customer to Set Reporting parameters, time frame and level of detail. The customer preferably initially evaluates and sets the configuration and management options for the Reporting Parameters that are comprised within the Configuration and Management Module as desired. The Reporting Management settings are preferably placed into the Subject Database where they affect and are stored in the Web Site Configuration & Management Settings table. (For more detailed descriptions of the Reporting Management Automation software see U.S. patent application publication No. 20010047290, herein incorporated totally by reference.)

Users may interact with the Reporting Management Automation software and preferably perform activities that: Search for Subjects, Add/Change Subjects, Rate Subjects, Comment on Subjects, Approve Adds/Changes, Ask Questions of other users, and Answer Questions from other users. These activities affect the Subject Database tables: Users; Subjects (Content); Activity History; and Application Status. The Subject Database tables content and/or changes are preferably input to the Customer/Management Reporting module which will perform the functions of providing reporting for: Overall User Status; Overall Status; Overall Content Status; Detail Content Status; Overall Status; and Detail Status. Upon reading the teachings of this specification, those with ordinary skill in the art will now understand that, under appropriate circumstances, considering such issues as advances in technology, user preference, user environment, etc., other reports, such as awards and contest status, user activity by type of activity analysis, etc., may suffice.

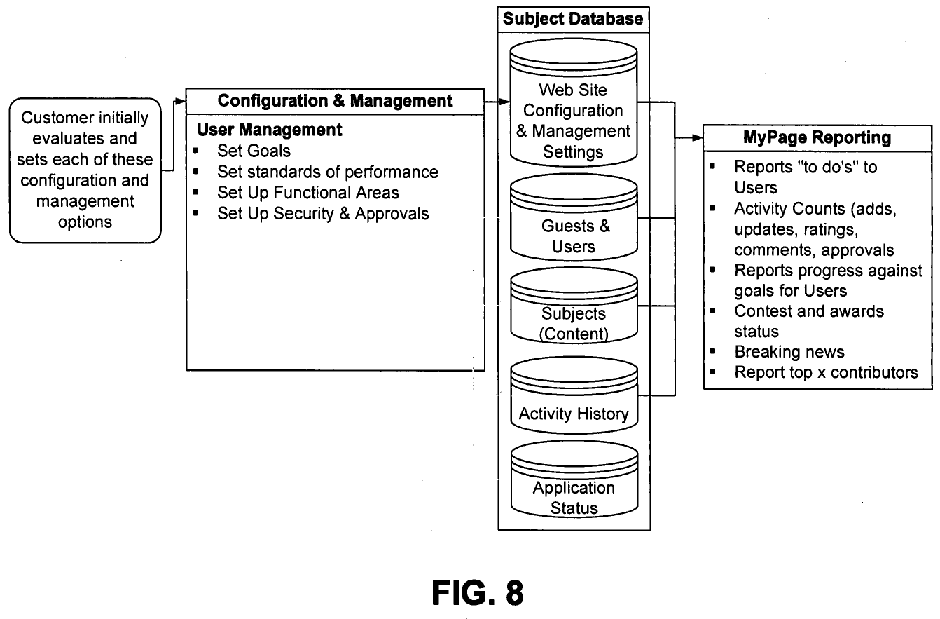

Referring to FIG. 8, a high level functional diagram of the User Management Automation software is shown. The core of the User Management Automation software is preferably comprised within the Configuration and Management Module. The Configuration and Management Module comprises User Management Automation software that comprises preferably activities to: Set goals for and users; and Set standards of performance (at least embodying herein automatically setting of goals for each user of such community; at least embodying herein computer software means for automatic setting of goals for each user of such community). The customer initially evaluates and sets the configuration and management options for the User Management Automation software, comprised within the Configuration and Management Module, as desired. The User Management settings are placed into the Subject Database where they preferably affect system operation and are stored in the Web Site Configuration & Management Settings table (at least embodying herein providing such computer systems to comprise software management systems to directly manage such at least one database and such community of users essentially without customer website management; at least embodying herein computer software means for direct automatic management of such at least one database and such community of users essentially without customer website management). (For more detailed descriptions of the User Management Automation software see U.S. patent application publication No. 20010047290, herein incorporated in total by reference.)

Users may interact with the User Management Automation software and perform activities that preferably: Search for Subjects, Add/Change Subjects, Rate Subjects, Comment on Subjects, Approve Adds/Changes, Ask Questions of other users, and Answer Questions from other users. These activities affect the Subject Database tables: Users; Subjects (Content); Activity History; and Application Status. The Subject Database tables content and/or changes are preferably input to the Reporting module which provides information to the Users preferably comprising: Reports “to do's” to users; Activity Counts (adds, updates, ratings, comments, approvals; Reports progress against goals for users; Report comments made; and Report top “x” number of contributors. Upon reading the teachings of this specification, those with ordinary skill in the art will now understand that, under appropriate circumstances, considering such issues as advances in technology, user preference, user location, etc., other reports reflecting any of the aspects of present inventions, etc., may suffice.

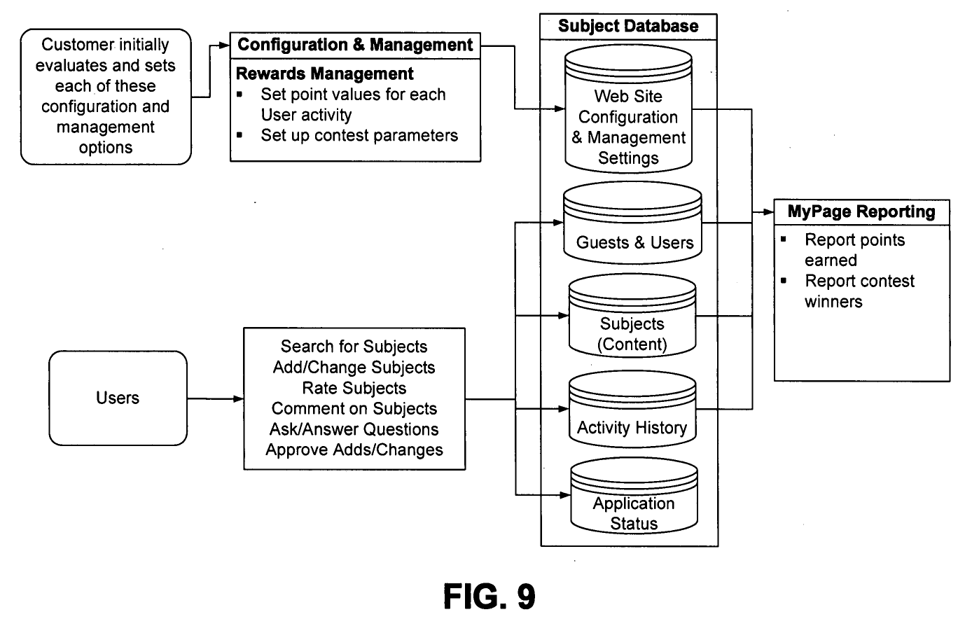

Referring to FIG. 9, a high level functional diagram of the Rewards Management Automation software is shown. The core of the Rewards Management Automation software is preferably comprised within the Configuration and Management Module. The Configuration and Management Module comprises the Rewards Management software that comprises, preferably, activities to: Set point values for each user & activity; Set dollar ($) value of points (optionally); Set up contest parameters e.g.: Number of entry points parameter, winners are selected randomly from the entrants, etc.; and set the setting of the % or the number (#) of people on the top lists (Top 100 subjects, top Contributors, Top Ratings, etc.). The customer initially evaluates and sets the configuration and management options for the Rewards Management that are comprised within the Configuration and Management Module as desired. The Rewards Management settings are placed into the Subject Database where they preferably affect and are stored in the Web Site Configuration & Management Settings table (at least embodying herein automatically managing at least one reward system to reward management efforts of each user of such community; at least embodying herein computer software means for automatically managing a reward system to reward efforts of each user of such community). (For more detailed descriptions of the Rewards Management Automation software see U.S. patent application, publication No. 20010047290, herein incorporated in total by reference.)

Users may interact with the Rewards Management Automation software and perform activities that preferably: Search for Subjects, Add/Change Subjects, Rate Subjects, Comment on Subjects, Approve Adds/Changes, Ask Questions of other users, and Answer Questions from other users. These activities affect the Subject Database tables: Users; Subjects (Content); Activity History; and Application Status. The Subject Database tables content and/or changes are preferably input to the Reporting module which provides information preferably comprising: Report points earned and money equivalent (optional); and Report contest winners.

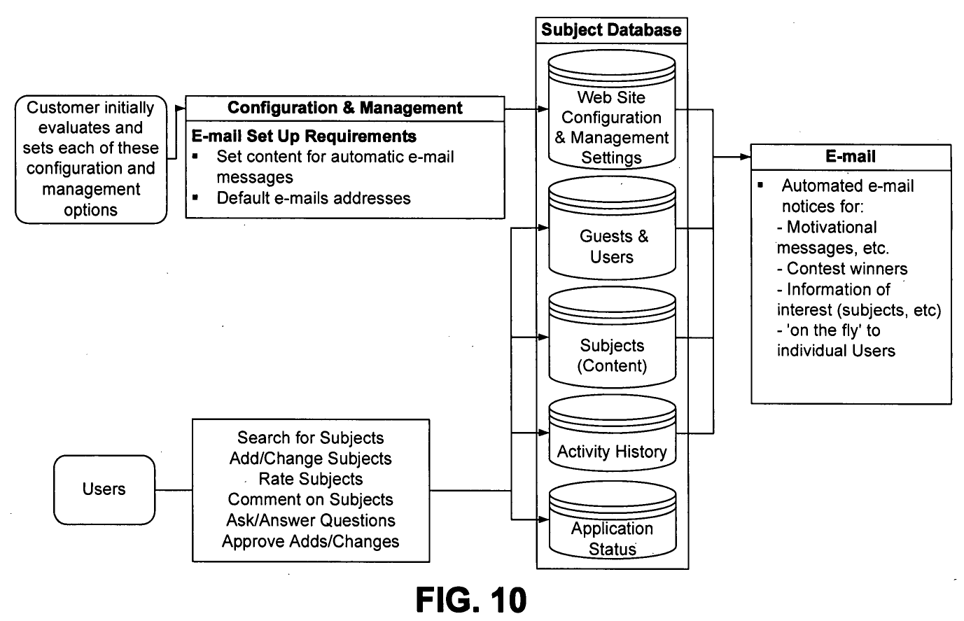

Referring to FIG. 10, a high level functional diagram of the E-mail Management Automation software is shown. The core of the E-mail Management Automation software is preferably comprised within the Configuration and Management Module. The Configuration and Management Module performs E-mail Management that preferably comprises the E-mail Set Up Requirements activities of allowing the Customer to: Set content for automatic e-mail messages, and Set Default e-mails addresses. For each of these activities, the customer preferably initially evaluates and sets each of these configuration and management options that are comprised within the Configuration and Management Module as desired. The E-mail Management settings are preferably placed into the Subject Database where they affect and are stored in the Web Site Configuration & Management Settings table. (For more detailed descriptions of the E-mail Automation Management software see U.S. patent application publication No. 20010047290, herein incorporated in total by reference.) Users may interact with the E-mail Management Automation software and preferably perform activities that: Search for Subjects, Add/Change Subjects, Rate Subjects, Comment on Subjects, Approve Adds/Changes, Ask Questions of other users, and Answer Questions from other users. These activities affect the Subject Database tables: Users; Subjects (Content); Activity History; and Application Status. The Subject Database tables content and/or changes are preferably input to the E-mail Module which will preferably provide for Automated e-mail notices comprising: Motivational emails of lives touched, etc.; Contest Winners; Information of Interest (Subjects, etc.); and ‘On the fly’ emails to individual users.

Web Site Automated Management

Preferably the Background Processes Module will preferably: Remove subjects (advice) with overall ratings below threshold; Remove subjects whose expiration date has passed with poor word ratings (optional); Calculate each user's personal credibility rating for ratings; Remove old ratings and recalculate ratings; and Remove old comments. Those with ordinary skill in this art will appreciate that minor differences in screen text, design and background are variations not critical to the instant inventions. (For more detailed descriptions of the functions of Background Processes Module see U.S. patent application publication No. 20010047290, herein incorporated totally by reference.)

Preferred System Operational Overview

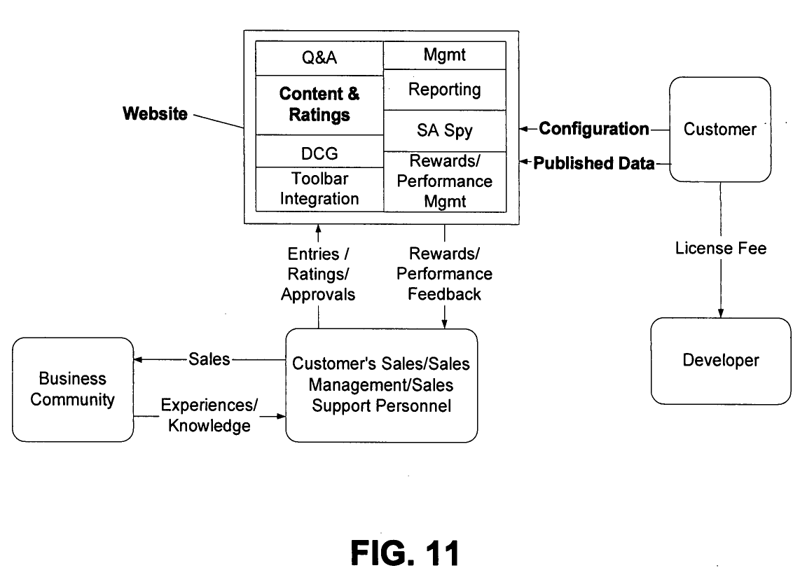

Referring to FIG. 11, the Website preferably comprises components and associated programming of: Questions and Answers, Content & Ratings (of usefulness in one ore more steps of a licensee defined sales cycle) Dynamic Content Generation (DCG), Toolbar Integration, Management, Reporting, SA Spy and Rewards/Performance Management. The Website interaction between the User Community (typically sales and sales related personnel) and the Website comprises not only rewards, but also performance feedback with regard to usage and contribution levels. Preferably, in addition to the Entries inputted by users the Website accepts content through interface software from Customer's various existing systems, providing users a much broader and deeper set of Content available in a single database.

The User Community may also obtain required information through the Question and Answer process which provides methods for experts to respond to questions posed by Users and make the questions and responses available to the User Community in the same manner as all other Entries. Additionally, Users may request automatic desktop notification of new Entries in their areas of interest through configuration and installation of the SA Spy module. A variety of reports are also available to the User Community which provide summary information and permit “drill down” to successively greater levels of detail. Also, the User Community now provides to the Website not merely Entries and Overall Ratings, but instead Entries, Usefulness Ratings and where in the sales cycle the Entry is most useful. Some key features in the preferred embodiment of the present invention are that the Website essentially does not require Management by a Developer/Operator/Site Manager and that the software of the Website performs management functions substantially automatically. (For more detailed descriptions of the automated management methods see U.S. patent application publication No. 20010047290, herein incorporated totally by reference.) Also, the Website substantially automatically interacts with the User Community to establish and maintain breadth, quality and currency of the Content through the Dynamic Content Generator (DCG).

Preferably Customers license the web site software from the developer based on the expected number of persons who will be granted access.

Preferred System Screens and Operation Details

Standardized Design Elements

In a preferred embodiment of the present invention, many of the key aspects of page design and common functionality are included as standard modules within the system. Examples of these standard functions include page header and footer process which are performed in essentially the same manner on every page in the system. In addition, standard templates are preferably used to ensure minimal deviation in each page's look and feel to the user.

Dynamic Content Generation

According to a preferred embodiment of the present invention, the dynamic content generation module is preferably intended to assist web site managers or management in the initial creation of database content (“seeding”) and then to continuously assist in the updating and evaluation of existing content. Once initial parameters and requests are established the process is capable of operating largely without management intervention. The web site manager or management is preferably required to make adjustments only when additional areas of information are required or other parameters require modification.

All user responses are reviewed and, if approved, added to the database as an experience, sales advice or other information accessible by other system users. The dynamic content generation module, through active solicitation of selected expert users, can preferably dramatically increase the amount and quality of database content. The dynamic content generation module preferably may also be used to actively request ratings of existing database entries by selected expert users.

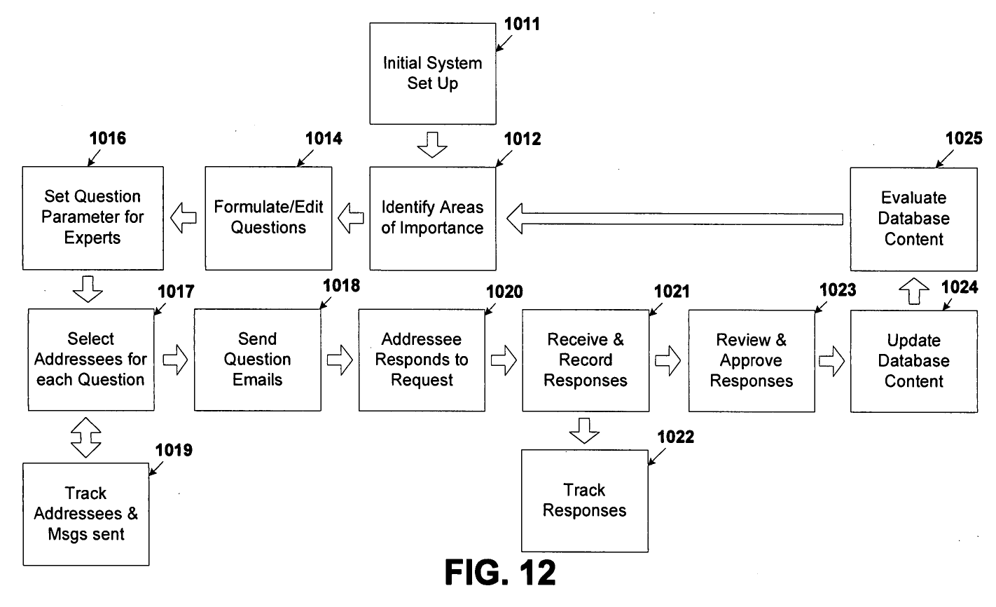

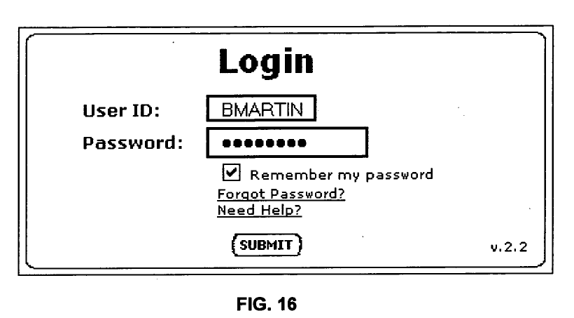

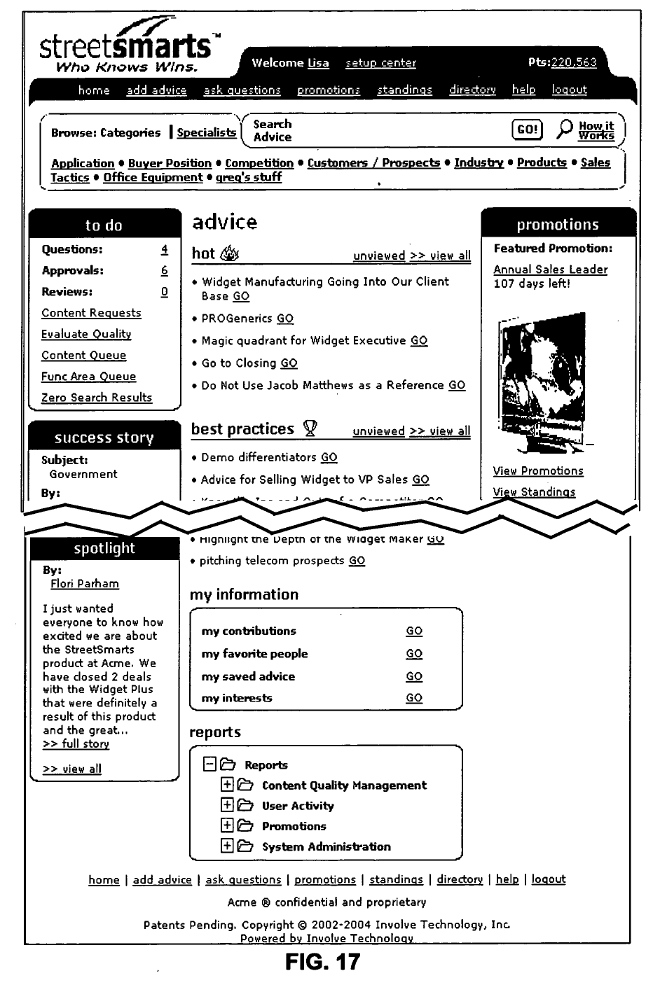

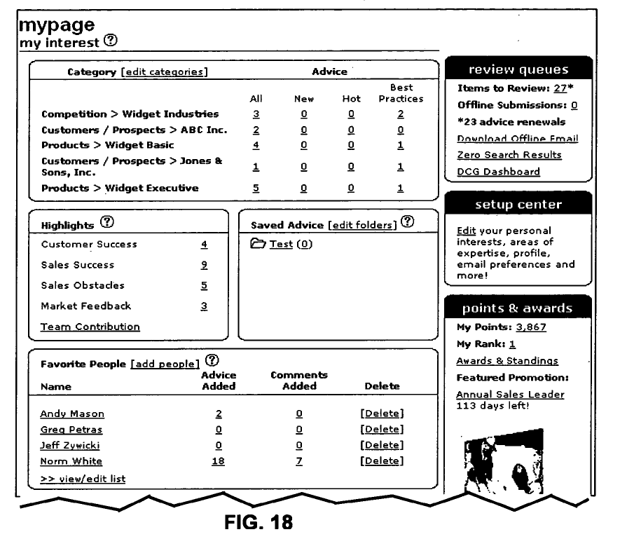

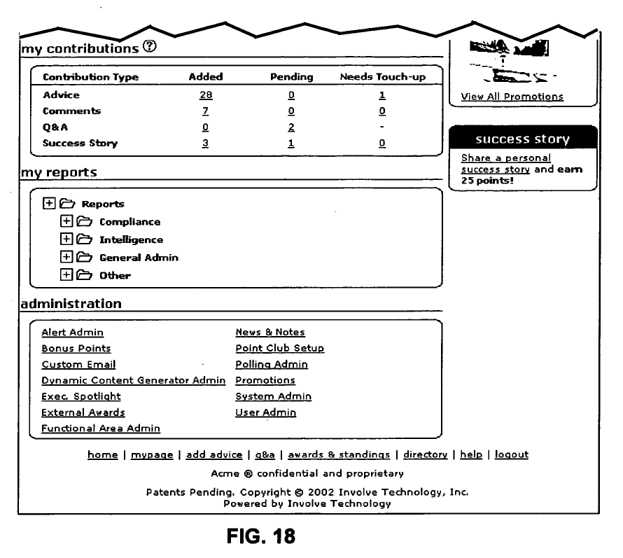

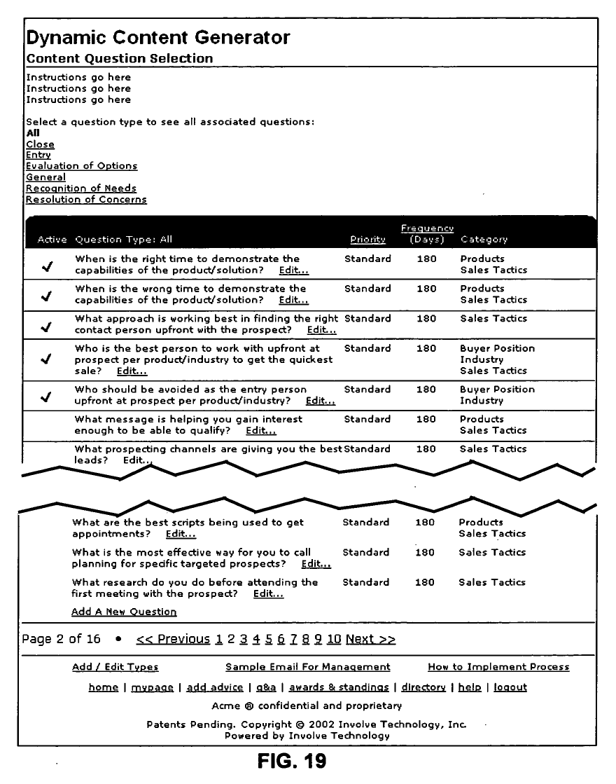

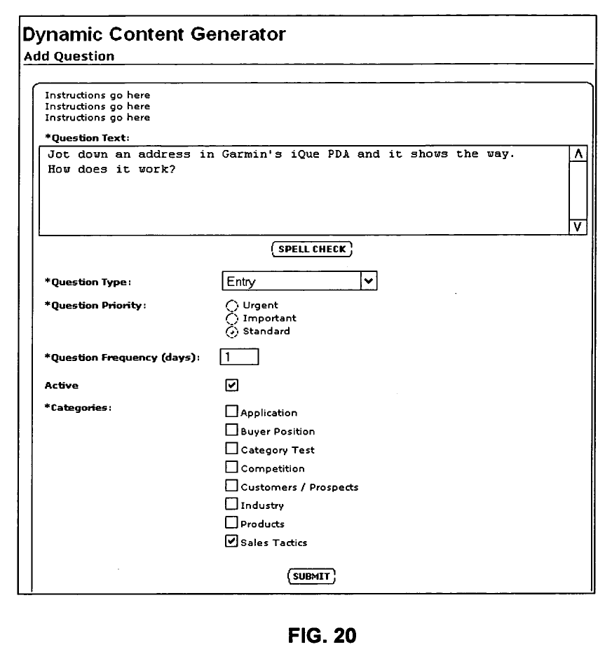

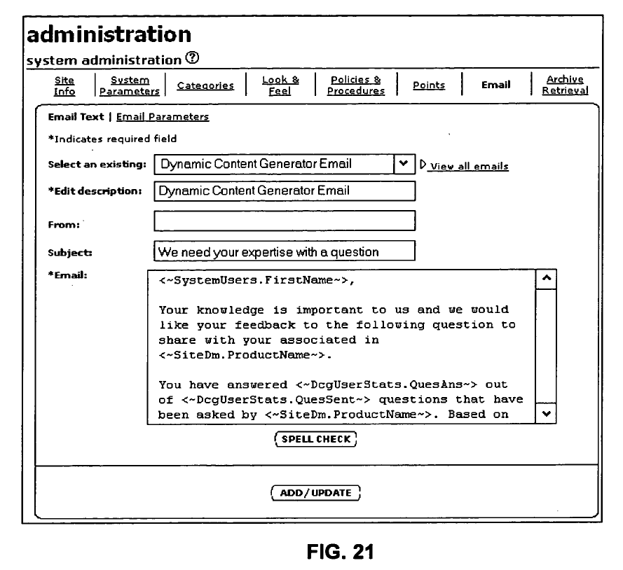

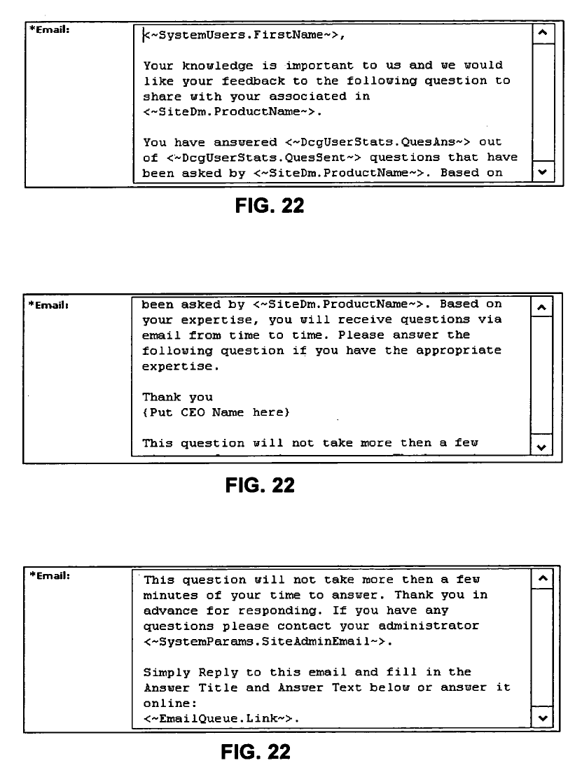

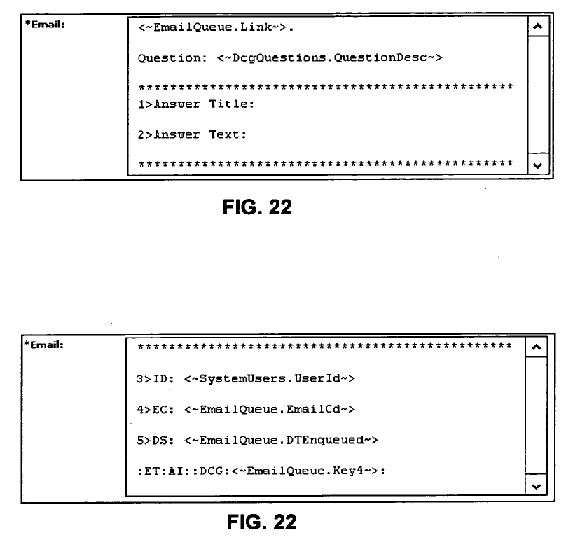

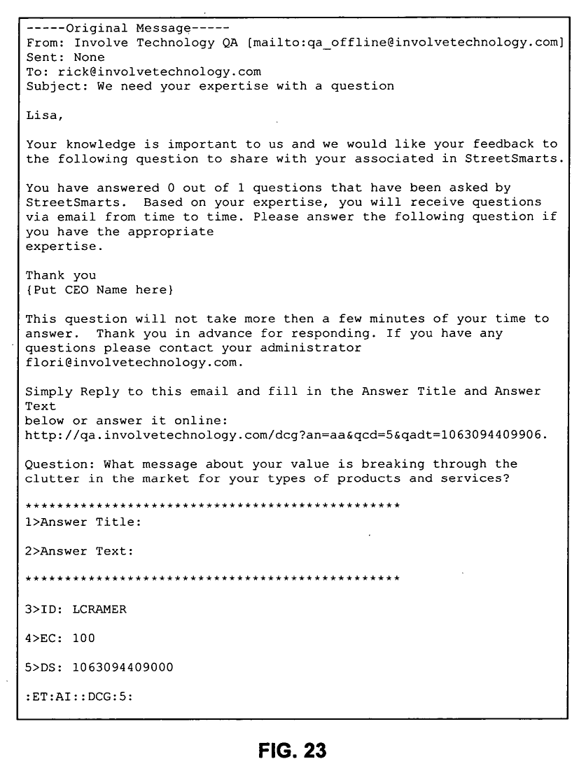

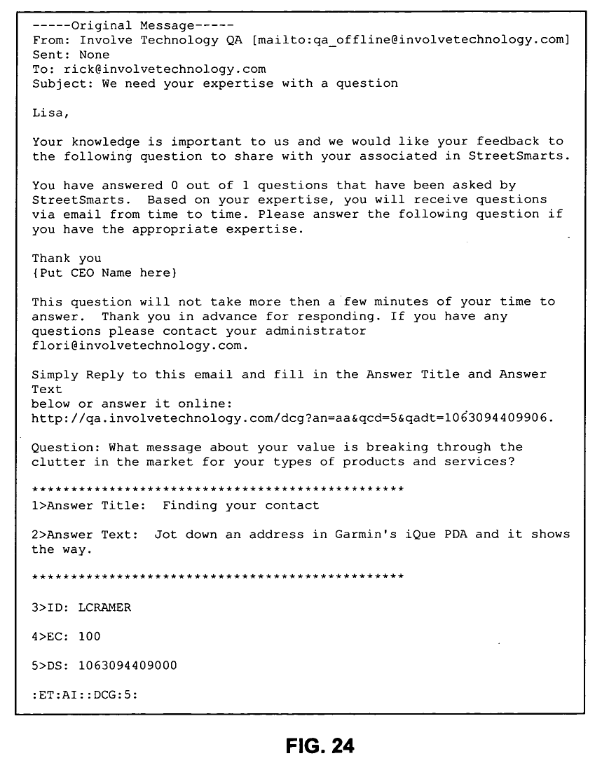

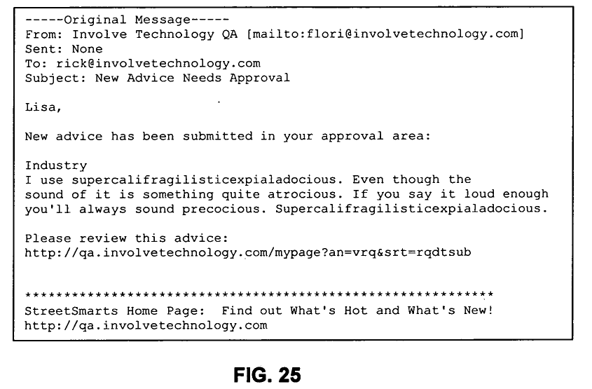

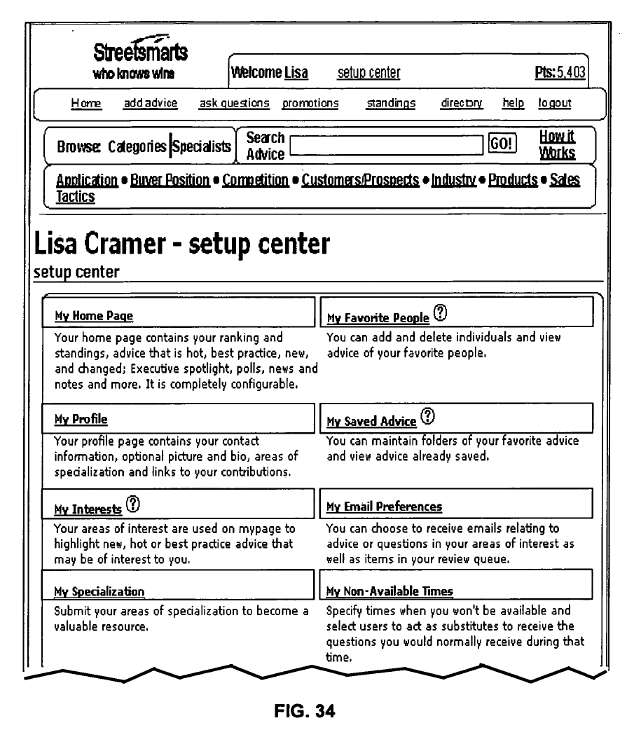

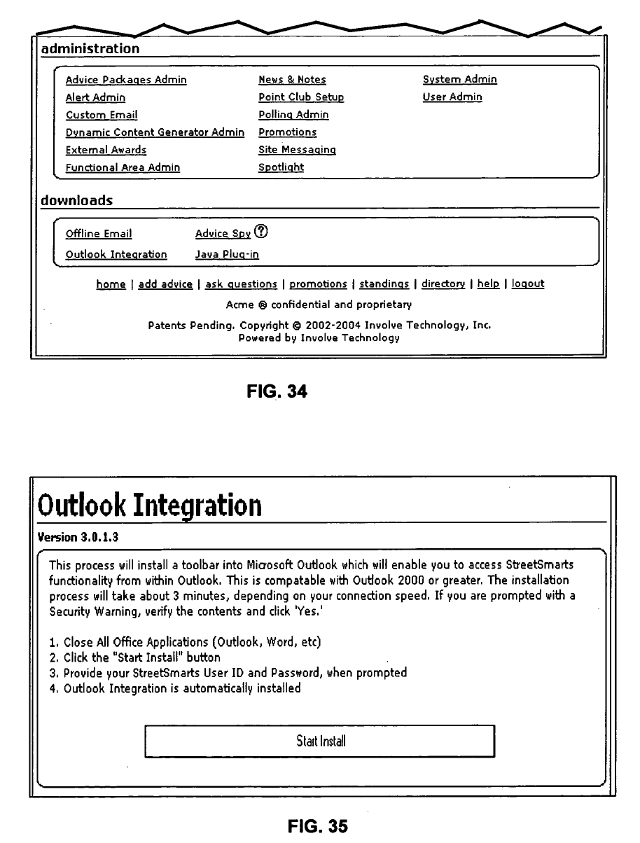

Referring now to FIG. 12, a preferred content generation process for initially and continuously requesting user participation in adding information (such as experiences or sales advice) to the database is shown. The process of requesting information starts with initial step of system set up 1011 in which the application is made available and web site manager completes initial training and familiarization. Preferably, the web site manager will also review and complete the required email forms used for sending the appropriate questions and receiving the responses as shown in FIG. 21 and FIG. 22 both at the outset of system start up and during the life of the system (at least embodying herein initially and continuously seeding such at least one database). Preferably, the email form is a “merge document” which permits variables to be inserted in the standard text of the email message so that each recipient only receives questions appropriate to their area of expertise. An example of completed merged email forms is shown in FIG. 23. An example of merged email form completed by a user is shown in FIG. 24. Also in the next step, identify areas of importance 1012 the web site manager or management preferably reviews the at least two hundred predefined questions delivered with the application and identifies those areas, or topic categories, which are highest priority for building information content in the database (at least embodying herein identifying at least one topic for which such specified information is to be requested; at least embodying herein processor means for identifying at least one topic for which such specified information is to be requested). Preferably once the high priority areas are identified and the predefined questions are reviewed the web site manager will begin to formulate requests for information in each high priority area in step formulate/edit questions 1014 (at least embodying herein formulating such at least one request for such specified information about at least one of such plurality of topics; at least embodying herein assigning each such at least one request to at least one primary topic; at least embodying herein computer input means for assisting formulating such at least one request for such specified information about at least one of such plurality of topics; at least embodying herein computer input means for assisting assigning each such at least one request to at least one primary topic). Preferably, the priorities assigned to questions are used to ensure the most important questions (requests for information) are sent to users most often (at least embodying herein assigning at least one priority to each such at least one request; at least embodying herein computer input means for assisting assigning at least one priority to each such at least one request). After logging in to the application as shown in FIG. 16, the web site manager or authorized user is presented with the home page as shown in FIG. 17. Preferably, the authorized user then selects the text link “set up center” and from the set up center page (FIG. 34) the user may select the text link “Dynamic Content Generation Admin” which will present the Content Question Selection screen which presents a list of questions, an example of the screen is shown in FIG. 19. (Optionally, the authorized user preferably then selects the text link “Mypage” to move to the Mypage screen as shown in FIG. 18 and from Mypage (FIG. 18) the user may select the text link “Dynamic Content Generation Admin” which will present the Content Question Selection screen which presents a list of questions, an example of the screen is shown in FIG. 19.) Selecting the “edit” text link associated with any question preferably presents a detail screen for editing an existing question as shown in FIG. 20. The same screen is preferably used for adding new questions when the authorized user selects the “add a new question” text link as shown in FIG. 19. As shown in FIG. 20, preferably each question is assigned a priority value and associated with a topic area (category is used throughout interchangeably with topic area) and the frequency with which each question is re-sent to expert users in the question's primary category (topic area). According to a preferred embodiment of the present invention, topic categories or categories are used to organize database content and to provide a means for classifying the expertise of users.

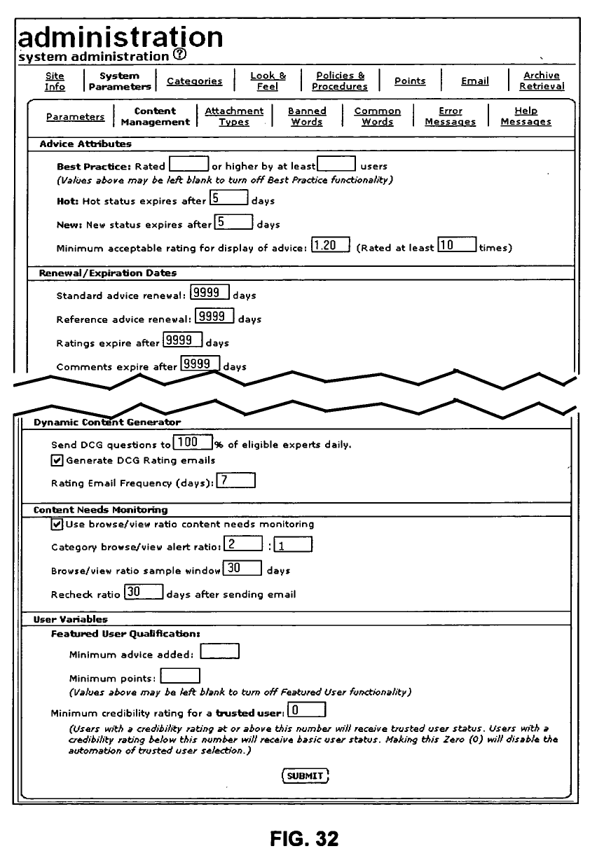

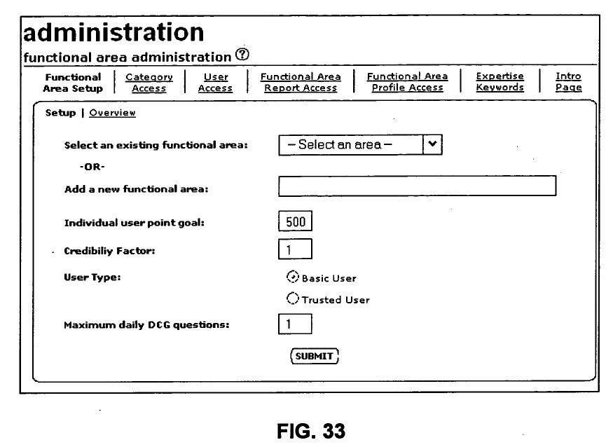

Referring again to FIG. 12, in the step set question parameter for experts 1016, preferably the web-site manager or management then sets the number of dynamic content generation questions each expert may receive each day and the percentage of experts to receive question each day (at least embodying herein limiting the number of such requests sent daily to each of such selected users knowledgeable about such at least one of such plurality of topics; at least embodying herein processor means for limiting the number of such requests sent daily to each of such selected users knowledgeable about such at least one of such plurality of topics). FIG. 33 illustrates the functional area administration screen where the value for the number of questions per day is set for each functional area and the timeframe for re-sending the questions (typically an organizational unit) (at least embodying herein setting the daily maximum number of such requests to be sent to such at least one user; at least embodying herein specifying the timeframe for re-sending each such at least one request to such at least one user; at least embodying herein computer input means for assisting setting the daily maximum number of such requests to be sent such to at least one user; computer input means for assisting specifying the timeframe for re-sending each such at least one request to such at least one user). This setting applies to all users identified as experts associated with the selected functional area (at least embodying herein identifying such plurality of users with known expertise in such primary topic of such at least one request; at least embodying herein processor means for identifying such plurality of users with known expertise in such primary topic of such at least one request). The functional area administration screen is preferably accessed from the set up center page (FIG. 34), or optionally, when used, from the Mypage screen as illustrated in FIG. 18. Additionally, FIG. 32 is an example of preferred system administration screen where the percentage of expert users to receive questions each day is set. The administration screen as shown in FIG. 32 is preferably accessed the from the set up center page (FIG. 34), or optionally, when used, from the from Mypage (FIG. 18) by selecting the link “system admin” then selecting the system parameters tab and then selecting the content management tab.

Preferably after completion of the step set # of questions sent to each expert 1016 the dynamic content generation process is configured to generate questions (requests for information) each day. In the step select addressees for each question 1017 preferably the dynamic content generation module uses the parameters and questions to send email forms to expert users each day.

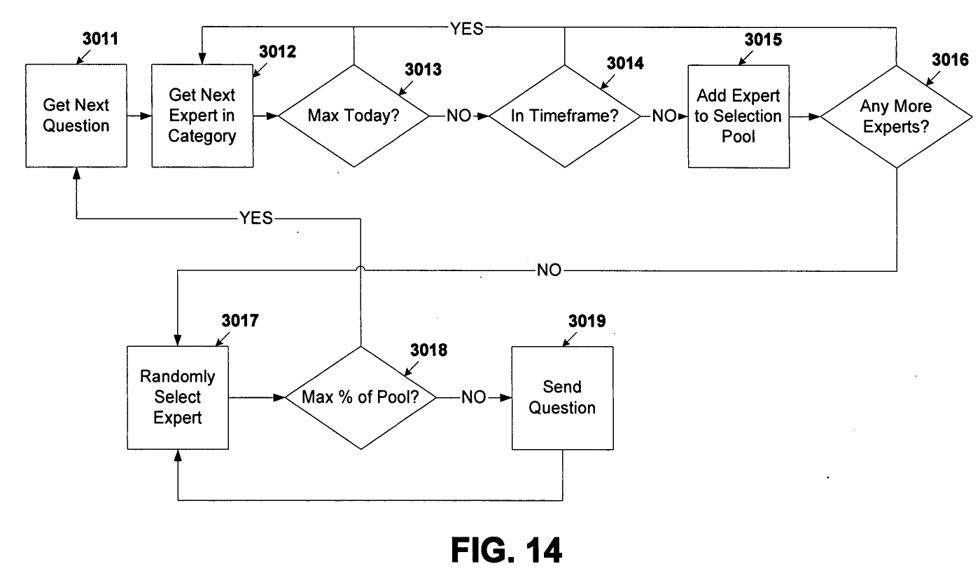

The logic process utilized for selecting each addressee is presented in FIG. 14. The process of requesting information from expert users continues each day until all questions in the database have been considered. Additionally, questions are considered in order of priority to ensure the highest priority questions (requests for information) are requested most often. Referring now to FIG. 14, preferably the process begins with selection of an active question from the database, as shown in step get next question 3011 (at least embodying herein formulating at least one request for such knowledge relevant to such at least one common goal; and at least embodying herein formulating at least one request for such particular subject information; at least embodying herein formulating at least one request for such specified information about at least one of such plurality of topics; at least embodying herein processor means for automatically selecting, for at least one request formulated for such specified information about at least one of such plurality of topics, at least one user of such plurality of selected users to receive such at least one request for such specified information). For each active question preferably a user identified as expert in the topic category associated with the question is selected in step get next expert in category 3012. In the step max today? 3013 preferably the number of information requests sent to the selected expert user is compared to the maximum number allowed for the expert user's functional area (see FIG. 33) (at least embodying herein limiting the number of such selected users which may receive such at least one request to a daily maximum percentage of all possible such selected users; at least embodying herein processor means for limiting the number of such selected users which may receive such at least one request to a daily maximum percentage of all possible such selected users). If number of questions sent on this day exceeds the maximum preferably the expert user is exempted and control is returned to the step get next expert in category 3012. If the number of questions sent on this day does not exceed the maximum number of questions, control preferably passes to the step in timeframe? 3014. In this step the elapsed time since the selected expert last submitted a response to the current question is preferably compared to the question frequency, in elapsed days, this question may be asked of any expert user (at least embodying herein for each such at least one request, referring to the latest such at least one transmittal record for each identified at least one user and such at least one request combination; at least embodying herein for each such at least one request, processor means for referring to the latest such at least one transmittal record for each identified at least one user and such at least one request combination). If the elapsed time (in days) since the expert user's last response is within the question frequency value (in days), the expert user is exempted from the question and control is returned to the step get next expert in category 3012 (at least embodying herein selecting only those users who have not received such request within the defined timeframe; at least embodying herein processor means for selecting only those users who have not received such request within the defined timeframe). If the elapsed time (in days) since the expert user's last response exceeds the question frequency value (in days), control is preferably passed to the step add expert to selection pool 3015 where the expert user will be included in the pool of experts eligible to receive the question (at least embodying herein sending such at least one request to selected at least one user who has not received such at least one request within such specified timeframe for each such at least one request; at least embodying herein processor means for sending such at least one request to selected at least one user who has not received such at least one request within such specified timeframe for each such at least one request). Preferably control then passes to step any more experts? 3016 where the next expert user in the topic category for the current question is found until all expert users have been considered. Once all expert users in the current question's topic category are evaluated control is preferably passed to step randomly select expert 3017 where eligible expert users are selected to receive the current question (at least embodying herein computer processor means for automatically selecting, relating to at least one request formulated to request specified knowledge about at least one of such plurality of kinds of experience, at least one user of such plurality of users to receive such at least one request for such specified knowledge; at least embodying herein automatically selecting at least one user of such group of users to receive such at least one request for such relevant knowledge; at least embodying herein automatically selecting at least one such user to receive such at least one request for such particular subject information; at least embodying herein automatically selecting at least one user of such plurality of selected users to receive such at least one request for such specified information; at least embodying herein selecting each such at least one user to receive such at least one request; at least embodying herein processor means for automatically sending such at least one request for such specified information to such at least one user; at least embodying herein processor means for automatically selecting at least one user of such plurality of selected users to receive such at least one request for such specified information; at least embodying herein processor means for selecting each such at least one user to receive such at least one request). After selection of an eligible expert user the percentage of eligible expert users selected is preferably compared to the percentage specified to receive questions each day in the step max % of pool? 3018. If the percentage selected is less than the maximum percentage (as shown in FIG. 32) the random selection process preferably continues and the questions are merged with the email form as shown in FIG. 22 for each selected user and are sent to the email server in step send question 3019 (at least embodying herein computer processor means for automatically sending such at least one request for such specified knowledge to such at least one user; and at least embodying herein automatically sending such at least one request for such relevant knowledge to such at least one user; at least embodying herein automatically sending such at least one request for such particular subject information to such at least one user; at least embodying herein automatically sending such at least one request for such specified information to such at least one user; at least embodying herein sending such at least one request to such at least one user; at least embodying herein adding at least one transmittal record, which includes at least one identifier of such at least one request, of delivery information for such at least one user and date and time of transmission, to such at least one database; at least embodying herein processor means for sending such at least one request to such at least one user; ;at least embodying herein processor means adding at least one transmittal record, which includes at least one identifier of such at least one request, of delivery information for such at least one user and date and time of transmission, to such at least one database). Once the maximum percentage is reached, preferably the process returns to the first step get next question 3011. This process is preferably repeated until all questions in the database have been have been considered.

Referring again to FIG. 12, in step 1018 preferably the messages received from the step select addressees for each question 1017 are sent to each addressee by a typical email server. In step track addressees and messages sent 1019 each question sent and the date and time are recorded when the merged form is sent to the email server (at least embodying herein recording content of such at least one request and delivery information for such at least one user; at least embodying herein processor means for recording content of such at least one request and delivery information for such at least one user). This history is used to determine the last date a question was sent to each expert user in step in timeframe? 3014 as shown in FIG. 14.

Referring to FIG. 12, in the step addressee responds to request 1020 each expert user receives the merged email form as shown in FIG. 22. After receiving the message the expert user replies to the message by completing the form appropriately, as shown in FIG. 24 and sending it back to the originating email address.

In the next step, receive and record responses 1021, the software preferably monitors the email “box” associated with the email address reserved for user's responses and evaluates each incoming email message, if the type of email message is a response to a question the information is reformatted and added to the review queue for review and approval by other authorized users (at least embodying herein computer processor means for receiving at least one reply from such at least one user to such at least one request for such specified knowledge; and at least embodying herein receiving at least one reply from such at least one user to such at least one request for such relevant knowledge; at least embodying herein receiving at least one reply from such at least one user to such at least one request for such particular subject information; at least embodying herein receiving at least one reply from such at least one user to such at least one request for such specified information; at least embodying herein processor means for receiving at least one reply from such at least one user to such at least one request for such specified information).

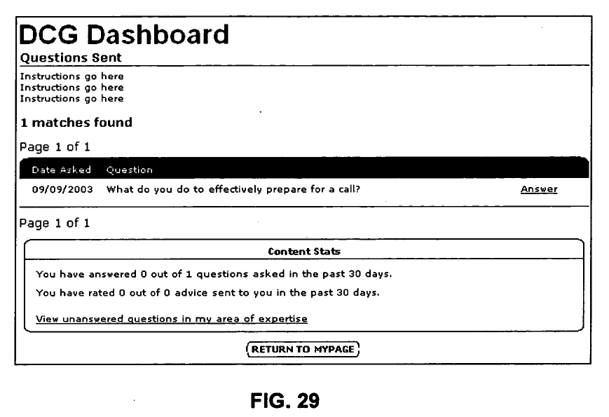

In the next step track responses 1022, preferably the all question responses are recorded and used to report overall performance to the user. This performance information is displayed on the DCG Dashboard as shown in FIG. 29 (at least embodying herein adding at least one receipt record, which includes at least one identifier of such at least one request, reply information for such at least one user and date and time of receipt of, to such at least one database; at least embodying herein processor means for adding at least one receipt record, which includes at least one identifier of such at least one request, reply information for such at least one user and date and time of receipt of, to such at least one database).

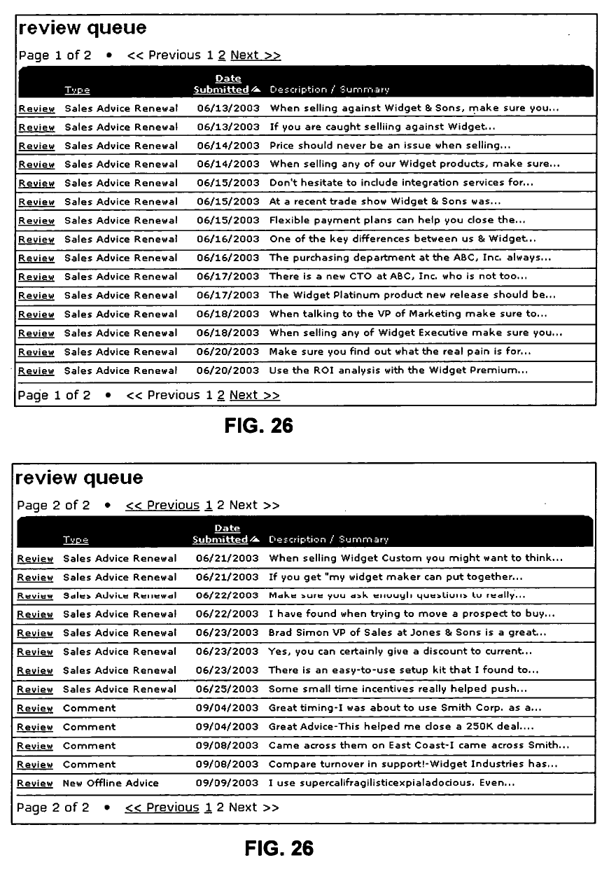

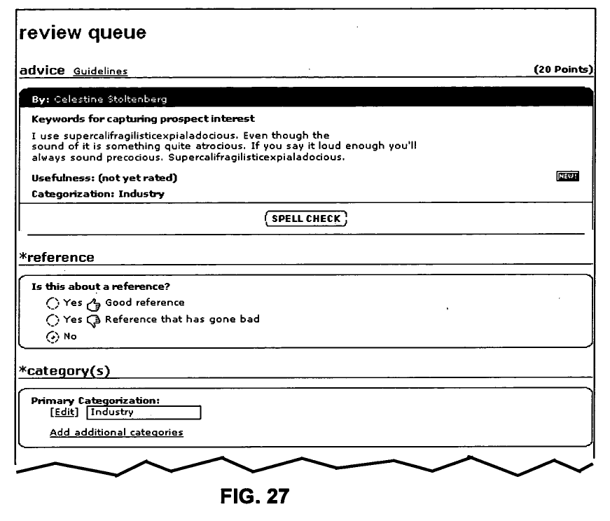

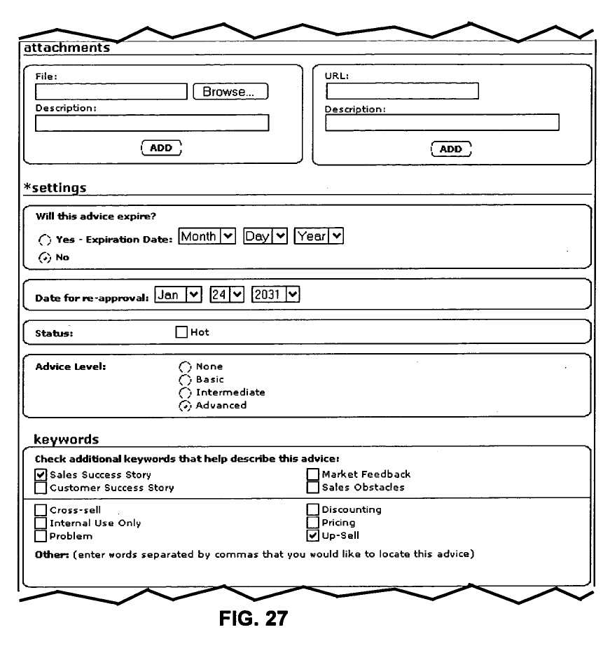

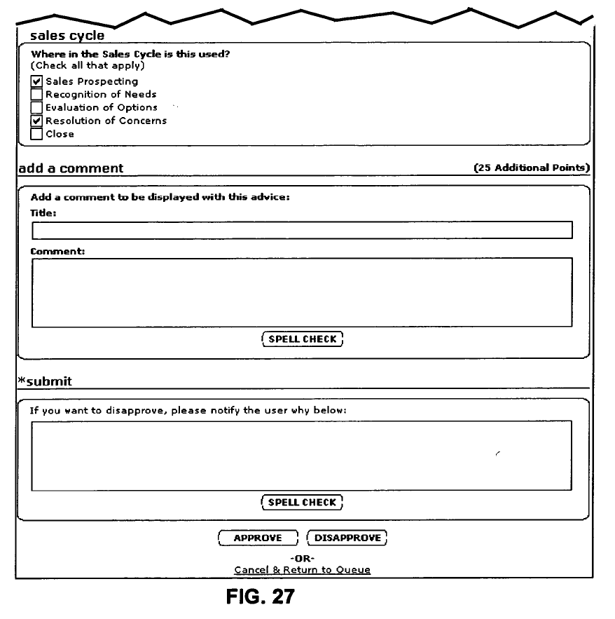

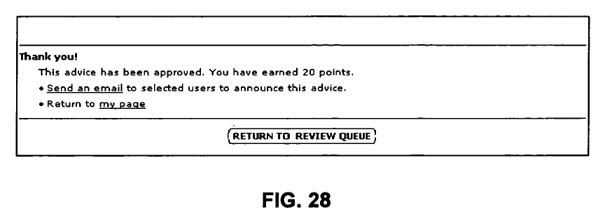

In the following step, review and approve responses 1023, preferably the usual review methods are used to review each response for approval of user submitted questions and responses Users authorized to review and approve submissions will receive email notification (see FIG. 23) that a response to the email request has been submitted. The reviewer then preferably accesses their queue of submitted subjects waiting for approval (see FIG. 26), selects the desired item and reviews it making any necessary changes and either approves or disapproves it (See FIG. 27 and FIG. 28) (at least embodying herein computer processor means for adding such received specified knowledge to such at least one database; and at least embodying herein adding such received relevant knowledge to such at least one database; at least embodying herein adding such received particular subject information to such at least one database; at least embodying herein adding such received specified information to such at least one database; at least embodying herein processor means for adding such received specified information to such at least one database). (For more detailed descriptions of the review methods see U.S. patent application publication No. 20010047290, herein incorporated totally by reference.). If the response to the question is found to be satisfactory it is approved by the reviewer to be added to the database (at least embodying herein approval of such at least one reply information by such at least one authorized user; at least embodying herein processor means for approval of such at least one reply information by such at least one authorized user; at least embodying herein adding such at least one reply information to such at least one database; at least embodying herein processor means for adding such at least one reply information to such at least one database). If the response is not satisfactory, preferably it is returned to the user for correction.

In the next step update database content 1024, preferably the approved response is added to the database and made available to all authorized users.

Finally, preferably management may review the quality and quantity of information in the database in the step evaluate database content 1025 using the available reporting tools (For more detailed descriptions and example of the reports see U.S. patent application publication No. 20010047290, herein incorporated totally by reference.). Preferably based on those evaluations the web site manager or management may choose to repeat the cycle by starting the step identify areas of importance 1012.

Rating Requests

According to a preferred embodiment of the present invention, the rating request portion of the dynamic content generation module is preferably intended to assist web site managers and management in the ongoing evaluation of database content. Preferably, once initial parameters are established the process is capable of operating largely without management intervention. The web site manager or management is preferably required to make adjustments only when additional areas of information are required or other parameters require modification.

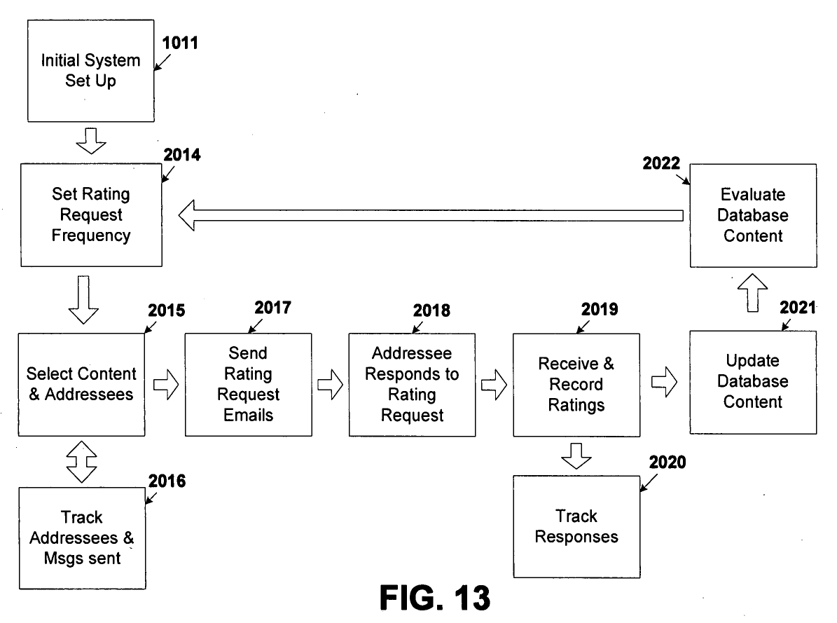

According to a preferred embodiment of the present invention, referring to FIG. 13, a preferred typical rating request process for initially and continuously requesting user ratings of database information (such as experiences or sales advice) is shown (wherein the specified information about the at least one plurality of topics comprises at least one rating of at least one reply of at least one other user). The process of requesting ratings starts with initial step of system set up 1011 in which the application is made available and web site manager and management complete initial training and familiarization.

In the next step, set rating request frequency 2014, the web site manager or management decides whether rating requests are required and, if so, sets the frequency in days in which ratings are requested of users. In other words, each entry in the database (such as experiences or sales advice) is subject to a review request after a prescribed number of days. An example of the screen for setting both parameters is shown in FIG. 32. The administration screen as shown in FIG. 32 is preferably accessed from the set up center page (FIG. 34), or optionally, when used, from the from Mypage (FIG. 18), by selecting the link “system admin” then selecting the system parameters tab and then selecting the content management tab.

Once the decision is made to request ratings and the rating frequency is set the process for selecting content for ratings operates automatically each day as shown in step select content and addressees 2015.

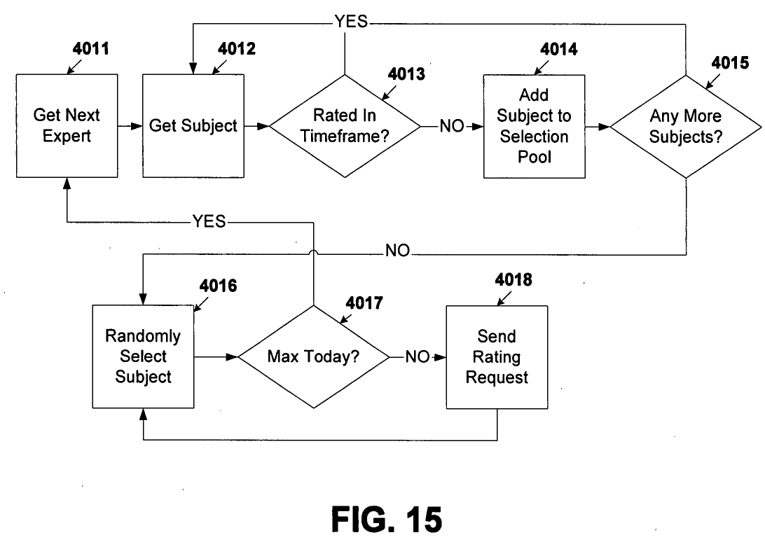

Referring now to FIG. 15, a schematic of the logic process utilized in step select content and addressees 2015 is presented. In summary, the process of sending ratings requests to expert users continues each day until all expert users in the database have been considered (at least embodying herein wherein such at least one selected user comprises a person knowledgeable about such at least one selected topic). As shown, the process begins with selecting an expert user in the step get next expert 4011. Once the expert user is obtained the next step, get subject 4012 uses the expert user's primary topic area of expertise (category) to locate subjects (experiences or sales advice) whose primary topic area matches the expert user's primary topic area of expertise. Once a subject is obtained the elapsed time since the selected expert user last submitted a rating on the current subject is preferably compared to the rating frequency in days within which subject ratings may be requested. If the elapsed time (in days) since the subject's last rating is within the question frequency value (in days) the subject is exempted from rating and control is returned to the step get next subject 4012. If the elapsed time (in days) since the subject's last rating exceeds the rating request frequency value (in days) control is preferably passed to the step add subject to selection pool 4014 where the subject will be included in the pool of subjects eligible to rated. Preferably control then passes to step any more subjects? 4015 where the next subject in the topic category for the current expert user is found until all subjects have been evaluated. Once all subjects in the current expert user's topic area expertise are evaluated control is preferably passed to step randomly select subject 4016 where eligible subjects are randomly selected for generation of a rating request to the current expert user. After selection of an eligible subject control passes to the step, max today? 4017 where preferably the number of requests sent to the selected expert user is compared to the maximum number allowed for the expert user's functional area (see FIG. 33). If number of requests sent on this day exceeds the maximum preferably the expert user is exempted and control is returned to the step get next expert 4011. If the number of requests sent on this day does not exceed the maximum number of requests (as shown in FIG. 33), control preferably passes to the step send rating request 4018. In the step send rating request 4018 the process preferably continues and the rating requests are merged with the appropriate email form and are sent to the email server. This process is preferably repeated until all expert users in the database have been have been considered.

Referring now to FIG. 13, in step 2017, preferably the messages received from the step select content and addressees 2015 are sent to each addressee by a typical email server. In step track addressees and messages sent 2016, each rating request sent and the date and time are recorded when the merged form is sent to the email server. This history is used to determine the last date a rating request was sent to each expert user in step in timeframe? 4013, as shown in FIG. 15.

Referring to FIG. 13, in the step addressee responds to rating request 2018 each expert user receives the merged email form. After receiving the message the expert user replies to the message by completing the form appropriately and sending it back to the originating email address.

In the next step, receive and record ratings 2019, the software preferably monitors the email “box” associated with the email address reserved for user's responses and evaluates each incoming email message, if the type of email message is a response to a rating request the information is reformatted and the appropriate subject rating is updated as shown in step update database content 2021.

In the next step track responses 2020, preferably the all rating request responses are recorded and used to report overall performance to the user. This performance information is displayed on the DCG Dashboard as shown in FIG. 29.

Finally, preferably management may review the quality and quantity of information in the database in step evaluate database content 2022 using the available reporting tools (For more detailed descriptions and example reports see U.S. patent application publication No. 20010047290, herein incorporated totally by reference.). Preferably based on those evaluations management may choose to make repeat the cycle by starting the step set rating request frequency 2014.

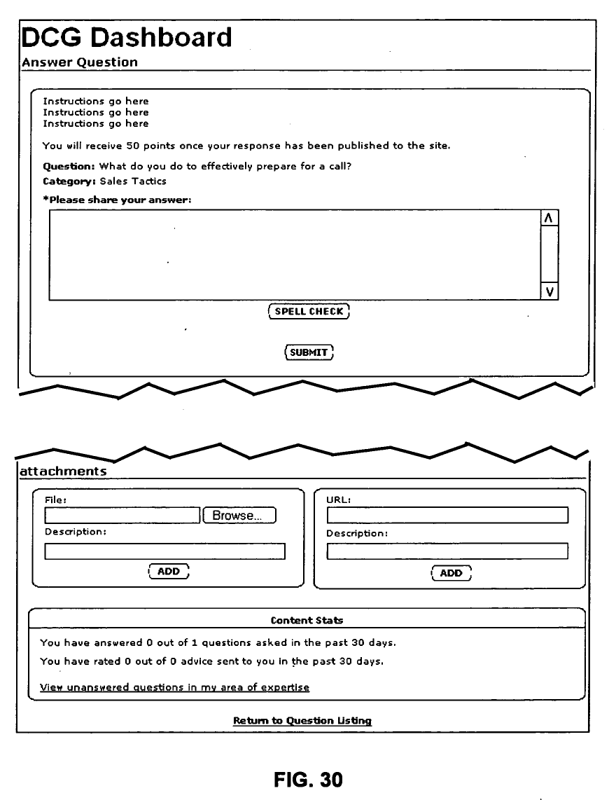

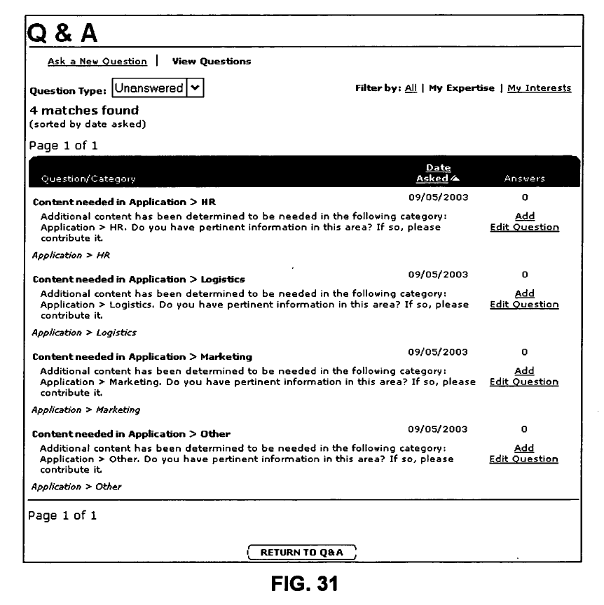

According to a preferred embodiment of the present invention, the dynamic content generation module also provides a facility to permit expert users, who receive requests to answer questions and rate existing subjects, to review their performance and open tasks. Preferably this information is presented on the user's home page in the “To Do” section, as shown in FIG. 17. Preferably, the user may select any count in the “To Do: section for unanswered questions and then complete the request using the review queue screen as shown in FIG. 26 and preferably select any displayed unanswered questions and complete the request using the answer question screen as shown in FIG. 30. Optionally, this information may be presented in the DCG Dashboard screen as shown in FIG. 29. Users may optionally access the DCG Dashboard screen, when used, from their Mypage screen as shown in FIG. 18, by selecting the “DCG Dashboard” text link displayed within the review queue box. Once on the DCG Dashboard screen (FIG. 29) the user may select any displayed unanswered questions and complete the request using the answer question screen as shown in FIG. 30. Additionally, the user optionally may select the text link “view unanswered questions in my area of expertise” which will preferably present a list of unanswered questions in the user's area of expertise, as shown in FIG. 31.

Integration Toolbar

According the a preferred embodiment of the present invention, preferably, as a means of promoting use of the instant system applicant provides a method of accessing several primary features of the instant system while the user is working in any one of several Microsoft applications, including Microsoft Word, Microsoft Excel, Microsoft PowerPoint and Microsoft Outlook. The integration toolbar operates essentially in the same manner for all Microsoft applications. However, additional functions are available from within Microsoft Outlook because it permits the presentation of browser content within its primary window. Upon reading the teachings of this specification, those with ordinary skill in the art will now understand that, under appropriate circumstances, considering such issues as advances in software technology, user preference, user location, etc., integration with other applications provided by other software publishers may suffice.

Referring now to FIG. 34, which is an example of the initial screen for setting up toolbar integration with Microsoft Office products according to a preferred embodiment of the present invention, each user may access this screen by selecting the text link “set up center” text link at the top of the home page (see FIG. 17). Each user may preferably then select the text link “Outlook Integration” shown near the bottom of the set up center page (FIG. 34 (2 of 2)).

Referring now to FIG. 35, which is an example of the installation start screen for Microsoft Office toolbar integration according to a preferred embodiment of the present invention, is presented to each user after selecting the text link “Outlook Integration”. This screen describes the integration toolbar installation process and then permits the user to start the download and installation process by selecting the “Start Install” button.

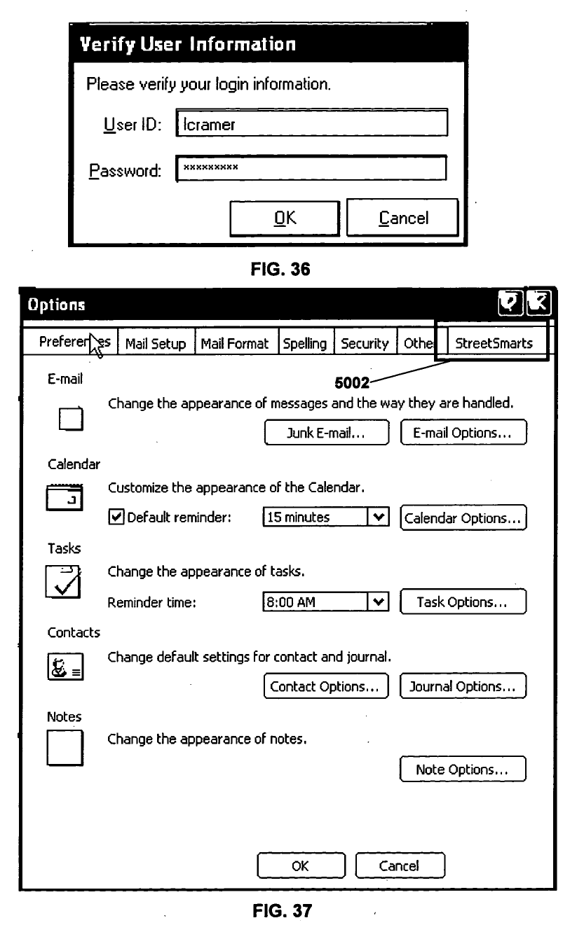

Referring now to FIG. 36, the verify user id and password screen which ensures only authorized users can install Microsoft Office toolbar integration according to a preferred embodiment of the present invention, is preferably presented immediately after the user selects the “Start Install” button from the previous screen. Preferably, the user is required to enter a valid user id and password before the installation process will proceed. Once a valid user id and password are provided the installation of the integration toolbar 5001 preferably proceeds without further user intervention. Preferably the user may receive error or warning messages to ensure various Microsoft Office applications are closed, however, preferably no further user action is required.

Referring now to FIG. 37, the Microsoft Outlook Options dialog box will include an additional tab for the present invention according to a preferred embodiment of the present invention, after successful installation of the integration toolbar 5001. This integration toolbar settings tab 5002 (shown as “StreetSmarts”) permits the user to complete or modify the variables associated with the instant invention as it relates to Microsoft Outlook. Preferably, the user may select the integration toolbar settings tab 5002 to access the variables which may be modified by the user.

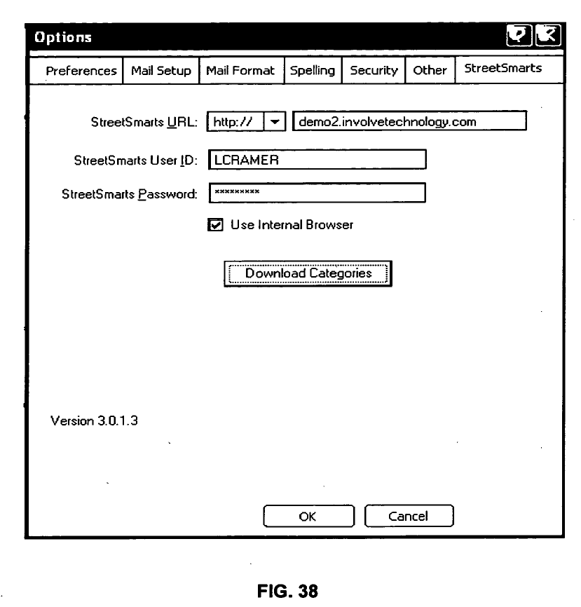

Referring now to FIG. 38, the integration toolbar options screen for the present invention accessed from within the Microsoft Outlook Options dialog box after installation of the Microsoft Office toolbar integration module, according to a preferred embodiment of the present invention, preferably provides the user the ability make the preferred website, their user id and password and to download the current list of categories used for classifying subjects and questions. Preferably the user may uncheck the checkbox for “use internal browser” which will force the toolbar to start the application in a browser window outside the integrated application. Selecting the “OK” button will apply any changes made by the user and return the user to the Microsoft Outlook Options dialog box. Selecting the “Cancel” button will discard any changes and return the user to the Microsoft Outlook Options dialog box.

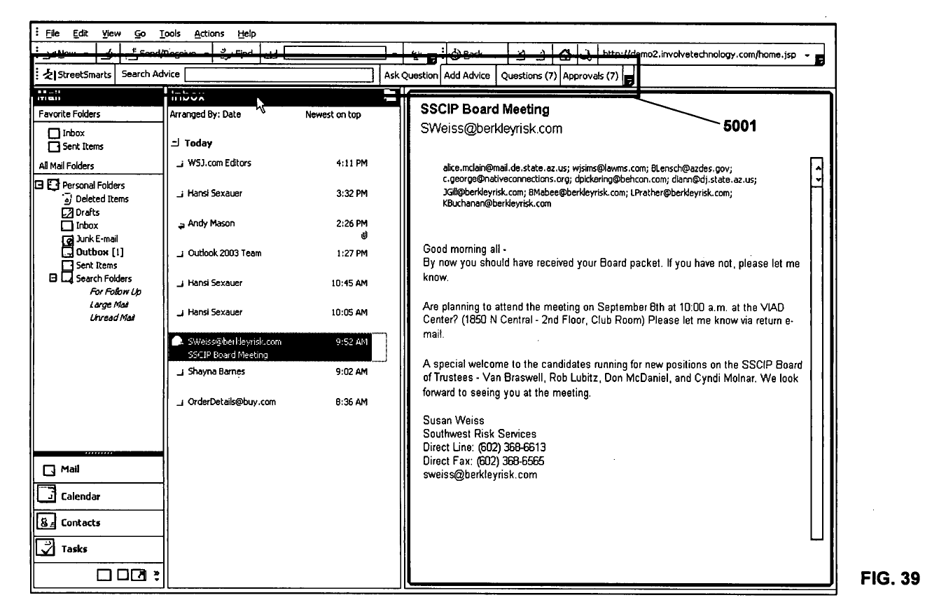

Referring now to FIG. 39, an example of how integration toolbar 5001 of the present invention is included within Microsoft Outlook, according to a preferred embodiment of the present invention is shown. The integration toolbar 5001 is preferably displayed for direct access of the present invention by the user. As shown in this example, preferably all other aspects of Microsoft Outlook remain unchanged; therefore a user may use Microsoft Outlook in a routine manner (at least embodying herein such at least one other computer-based system comprises at least one computer-based email system; at least embodying herein wherein such at least one other computer-based system is manufactured by Microsoft Corporation). However, when the user chooses any text link from the integration toolbar 5001 that function of the present invention is presented to the user (at least embodying herein computer integration means for providing from within at least one other computer-based system at least one first button for accessing such interface means for user-searching to select at least one desired kind of such stored at least one experience; at least embodying herein providing from within at least one other computer-based system at least one first button for user-searching to select at least one desired kind of stored experience; at least embodying herein providing from within at least one other computer-based system at least one first button to so search for such particular subject information; at least embodying herein computer integration means for providing from within such at least one other computer-based system at least one second button for accessing such computer interface means for individually capturing at least one experience of at least some of such plurality of such users; at least embodying herein providing from within such at least one other computer-based system at least one second button for individually capturing for such at least one database at least one experience of at least some of such plurality; at least embodying herein providing from within such at least one other computer-based system at least one second button to individually capture for such at least one database at least one such particular subject information; at least embodying herein computer integration means for providing from within such at least one other computer-based system at least one second button to individually capture for such at least one database at least one such particular subject information; at least embodying herein at least embodying herein computer integration means for providing from within such at least one other computer-based system at least one third button for accessing computer interface means for formulating at least one request for such specified knowledge; at least embodying herein providing from within such at least one other computer-based system at least one third button for formulating at least one request for such specified knowledge; at least embodying herein providing from within such at least one other computer-based system at least one third button for formulating at least one user request for at least one such particular subject information; at least embodying herein computer integration means for providing from within such at least one other computer-based system at least one other button for accessing computer interface means for approving such at least one stored experience; at least embodying herein providing from within at least one other computer-based system at least one other button for approving such at least one stored experience; at least embodying herein providing from within such at least one other computer-based system at least one other button for approving at least one such particular subject information; at least embodying herein computer integration means for providing from within such at least one other computer-based system at least one additional other button for accessing computer interface means for responding to such at least one formulated request for such specified knowledge; at least embodying herein providing from within such at least one other computer-based system at least one additional other button for responding to such at least one request for such particular subject information; at least embodying herein providing from within at least one other computer-based system at least one additional other button for responding to such at least one formulated request for such specified knowledge; at least embodying herein computer integration means for providing from within such at least one other computer-based system at least one yet additional other button for accessing computer interface means for displaying at least one web page of such Internet client-server system; and at least embodying herein providing from within at least one other computer-based system at least one yet additional other button for displaying at least one web page of such Internet client-server system; at least embodying herein providing from within such at least one other computer-based system at least one yet additional other button for displaying at least one web page of such web computer system; at least embodying herein establishing at least one inter-program link between at least one first computer program and at least one second computer program). When the user has completed use of the present invention he or she may return to Microsoft Outlook by selecting any of the Microsoft Outlook functions displayed on the screen. Upon reading the teachings of this specification, those with ordinary skill in the art will now understand that, under appropriate circumstances, considering such issues as user preference, the nature of the application and changes in technology, etc., other methods and locations of displaying the integration toolbar 5001 may suffice.

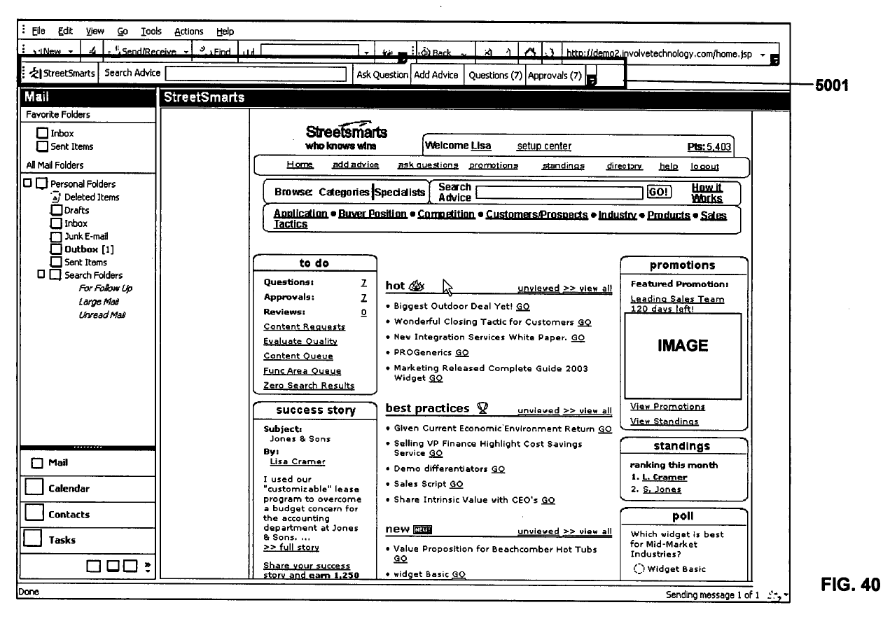

Referring now to FIG. 40, an example screen display after the present invention was selected using the “StreetSmarts” text link from the integration toolbar 5001 from within Microsoft Outlook, according to a preferred embodiment of the present invention, demonstrates a preferred method of displaying the present invention “inside” Microsoft Outlook. Preferably, selecting the “StreetSmarts” text link from the integration toolbar 5001 displays the home page of the present invention which then permits the user to access any function or area of the present invention without restriction just as if the present invention had been started from within a browser.

Referring now to FIG. 41, a diagrammatic representation of the integration toolbar 5001 of the present invention, according to a preferred embodiment of the present invention, shows various text links available to the user. Preferably, the “StreetSmarts” text link permits the user to start the present invention from within Microsoft Outlook as shown in FIG. 40. Preferably the combination of “Search Advice” text link and entry field is a shortcut that permits a user to immediately search for all subject entries in subject database of the present invention using the keyword search methods (For more detailed descriptions of the keyword search methods see U.S. patent application publication No. 20010047290, herein incorporated totally by reference.).

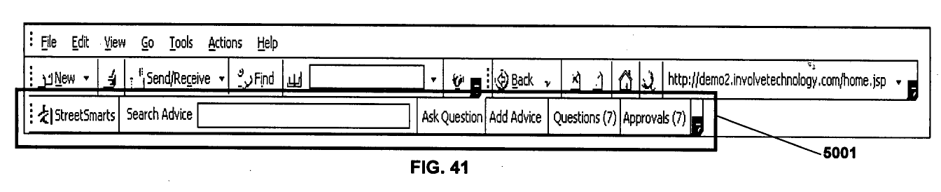

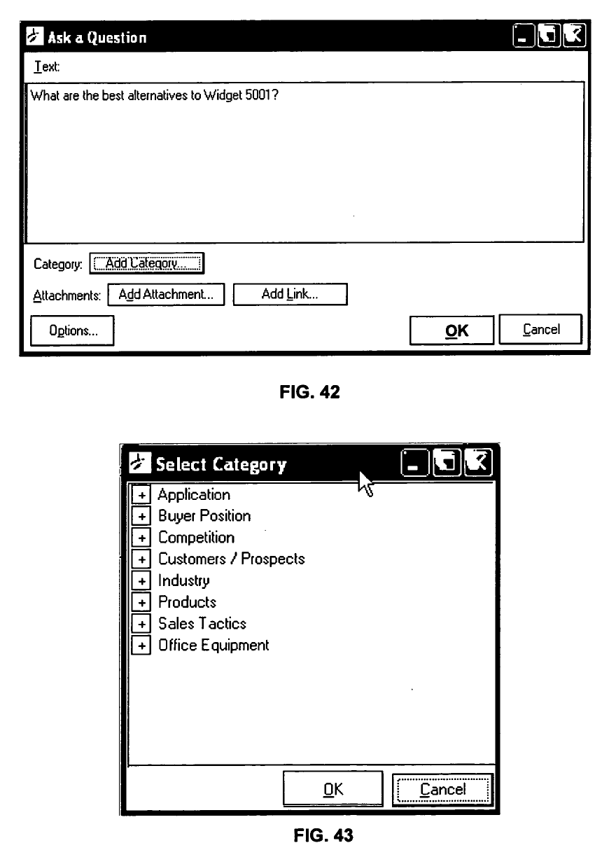

Preferably, the “Ask Question” text link is a shortcut which permits the user the immediately formulate a question and submit it to the users of the present invention. (Refer to FIG. 42 through FIG. 50.)

Preferably, the “Add Advice” text link is a shortcut which permits the user to immediately formulate a subject entry for the subject database (at least embodying herein starting such at least one first computer program). (Refer to FIG. 51 through FIG. 53.)

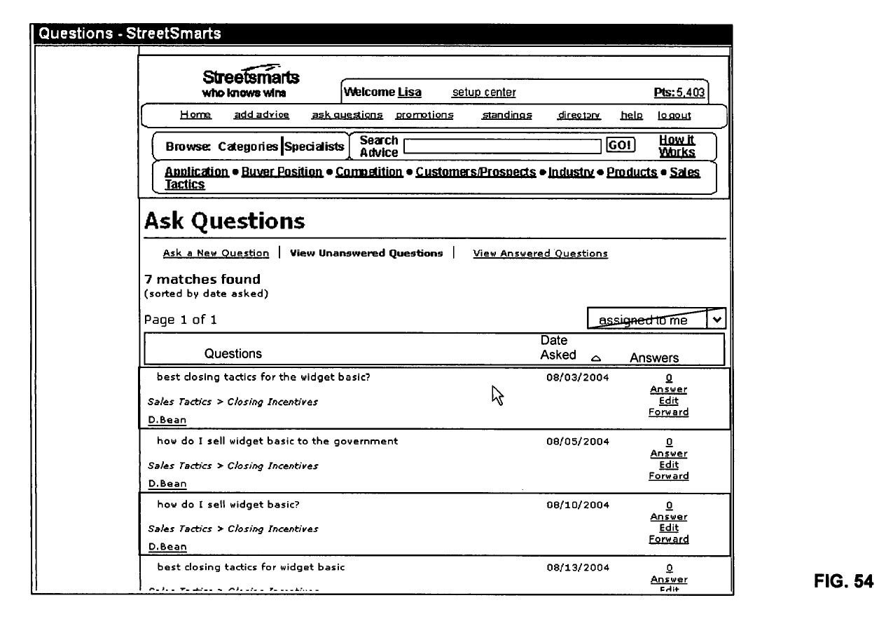

Preferably, the “Question (n)” text link is a shortcut which permits the user to immediately access a display of all questions assigned to the user which are awaiting a response by the user. (Refer to FIG. 54.) Preferably, the number in parentheses represents a count of the number of items in the queue.

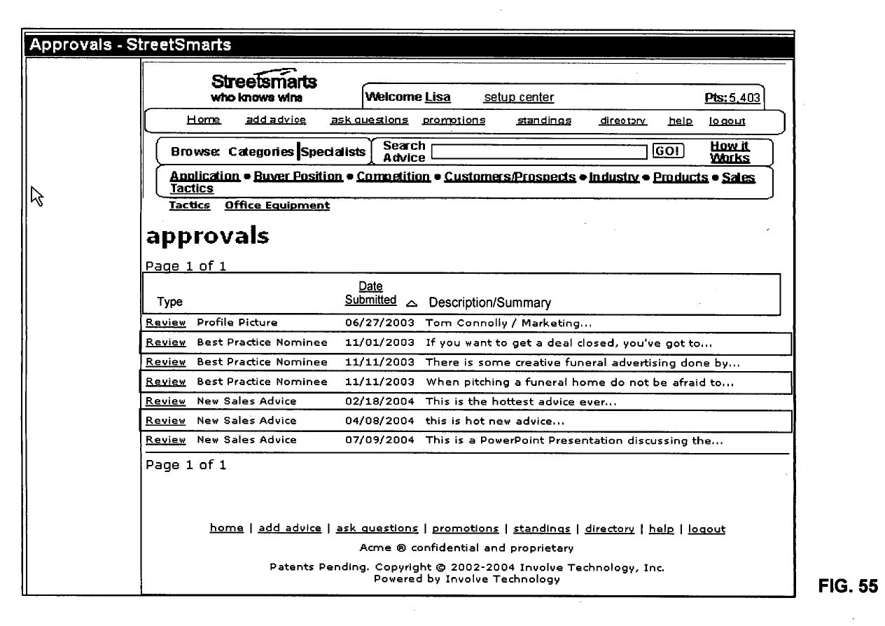

Preferably, the “Advice (n)” text link is a shortcut which permits the user to immediately access a display of all subject submissions which are awaiting a approval action by the user. (Refer to FIG. 55.) Preferably, the number in parentheses represents a count of the number of items in the queue.

Referring now to FIG. 42, shown is the “Ask a Question” dialog presented to a user after selecting the “Ask Question” text link on the integration toolbar 5001 of the present invention, according to a preferred embodiment of the present invention. Preferably this dialog is presented to the user in the same manner as all other displays from within Microsoft Outlook. Preferably the user may enter the question in the text box then select one or more of the various buttons to complete the question before submitting it.

Referring now to FIG. 43, shown is an example of the “Add Category” dialog box presented to a user after selecting the “Add Category” button from within the “Ask a Question” dialog box (FIG. 42) of the present invention which permits a user to complete and submit a question to the other users of the present invention, according to a preferred embodiment of the present invention. Preferably, the user will use the Add Category dialog box to classify the question in the most appropriate category which ensures the question will be routed to the most appropriate expert(s). Preferably, the user may select one or more categories, as appropriate.

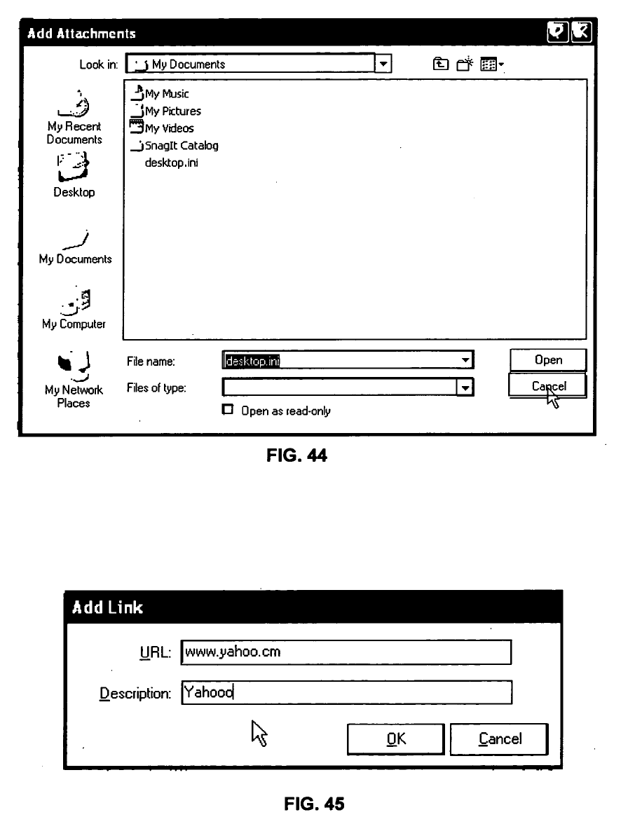

Referring now to FIG. 44, shown is an example Add Attachment dialog box presented to a user after selecting the “Add Attachment” button from within the “Ask a Question” dialog box of (FIG. 42) the present invention permitting a user to add a document as an attachment to a question, according to a preferred embodiment of the present invention. Preferably, if the user has a question regarding a document it may be attached to the question when it is submitted to permit the expert the opportunity to review the document while answering the question. Selecting a document and selecting the Open button will associate the document with the question and return the user to the “Ask a Question” dialog box.

Referring now to FIG. 45, shown is an example “Add Link” dialog box presented to a user after selecting the “Add Link” button from within the “Ask a Question” dialog box (FIG. 42) of the present invention permitting a user to add an URL address link to a question, according to a preferred embodiment of the present invention. Preferably, the user may specify and describe a particular URL which may be relevant to the question being posed. Preferably the expert then has the opportunity to review the associate web content while answering the question. Selecting the “OK” button will preferably associate the URL address with the question and return the user to the “Ask a Question” dialog box (FIG. 42).

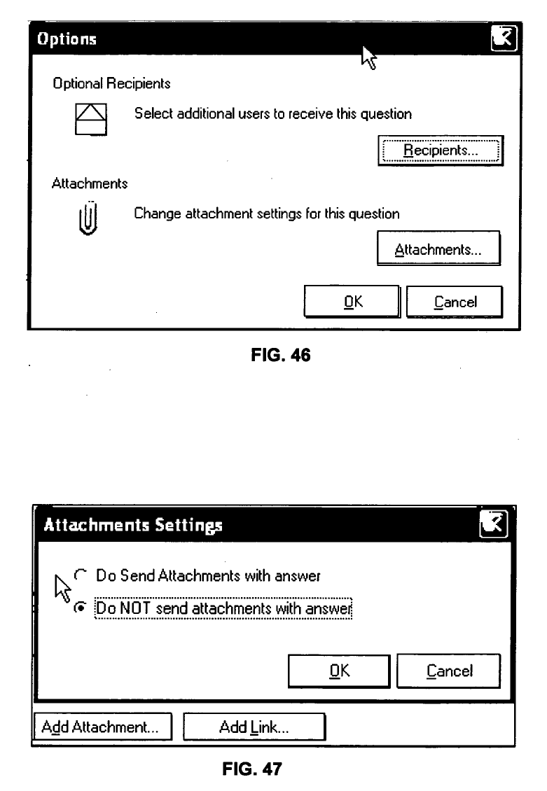

Referring now to FIG. 46, shown is an example “Options” dialog box presented to a user after selecting the “Options” button from within the “Ask a Question” dialog box of the present invention permitting a user to select additional options for the current question, according to a preferred embodiment of the present invention. Preferably the user may use the “Options” dialog to specify particular recipients or functional areas of the organization which the user believes may be best able to answer the question. The user may preferably also use this dialog box to modify the default attachment setting for the current question. Selecting the “OK” button will preferably return the user to the “Ask a Question” dialog box (FIG. 42).

Referring now to FIG. 47, illustrated is an example “Attachments Settings” dialog box presented to a user after selecting the “Attachments” button from within the “Options” dialog box (FIG. 46) of the present invention permitting a user to select attachment options for the current question, according to a preferred embodiment of the present invention. As shown, preferably the user may choose to have the original attachment returned with the answer or to receive only the answer without the original attachment. Preferably the user also has the option to select the “Attachments” button to associate additional attachments with the current question. Preferably the user also has the option to select the “Add Link” button to associate additional URL addresses with the current question. Selecting the “OK” button will preferably return the user to the “Options” dialog box (FIG. 46).

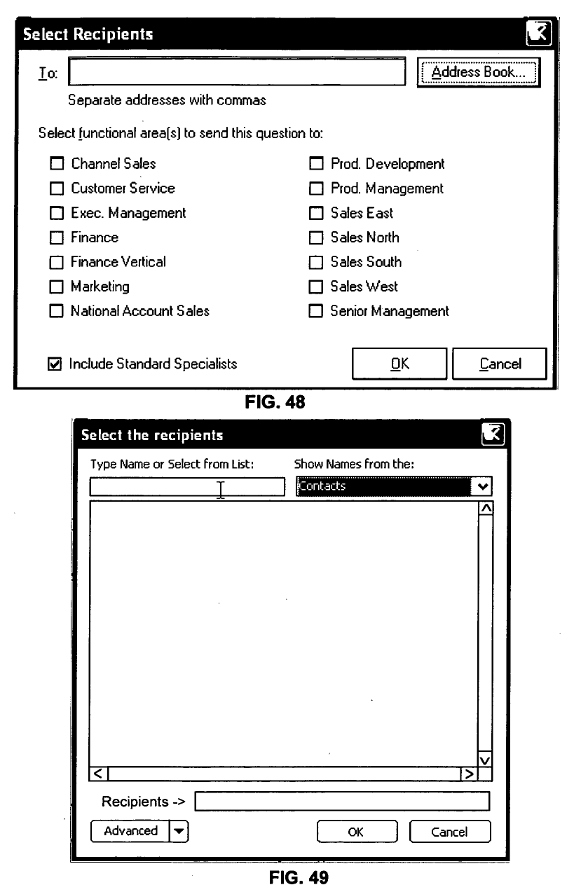

Referring now to FIG. 48, illustrated is an example “Recipients” dialog box presented to a user after selecting the “Recipients” button from within the “Options” dialog box of the present invention permitting a user to select additional individuals and/or functional areas to receive the current question, according to a preferred embodiment of the present invention. Preferably, the user may enter the email addresses of the intended recipients in the text box or selecting them from an address book, including the Microsoft Outlook address book by selecting the “Address Book” button. Selecting the “OK” button will preferably return the user to the “Options” dialog box (FIG. 46).

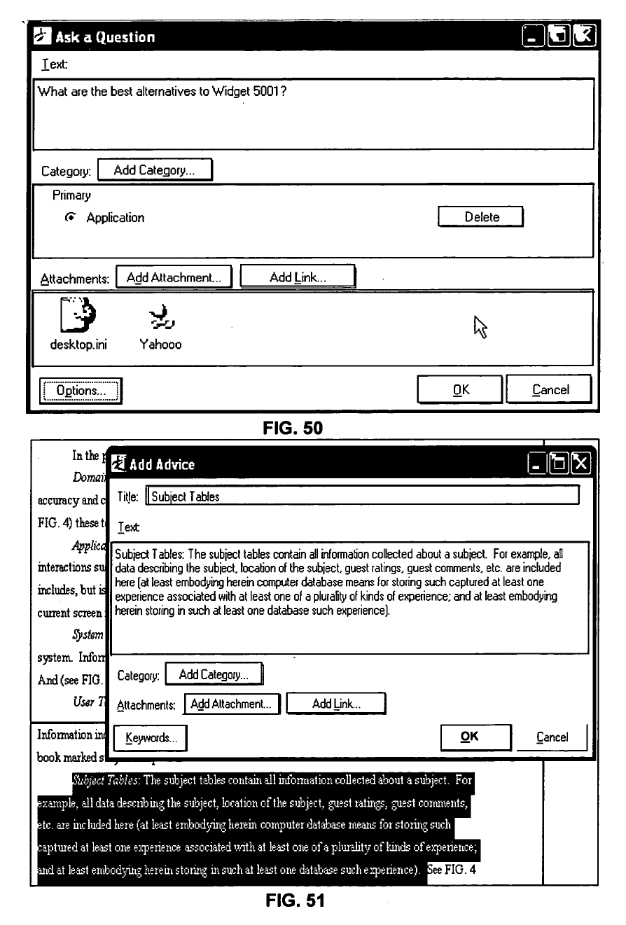

Referring now to FIG. 49, illustrated is an example “Address Book” dialog box presented to a user after selecting the “Address Book” button from within the “Select Recipients” dialog box of the present invention permitting a user to select particular individuals to receive the current question, according to a preferred embodiment of the present invention. Preferably the user may use the Microsoft Outlook address book as a source of names and email address to whom the question will be sent. Selecting the “OK” button will preferably will result in the addressees receiving the question and return the user to the “Options” dialog box (FIG. 46).

Referring now to FIG. 50, shown is an example screen display of a completed “Ask a Question” dialog according to a preferred embodiment of the present invention. Preferably after the user has completed the steps of entering the question, associating it with one or more categories, adding any documents or URL addresses as attachments and adding additional recipients a summary of the question is presented for review and to permit the user to make any changes any of the items before submitting it. Selecting the “OK” button will preferably submit the question and return the user to the previously active window within Microsoft Outlook.

Referring now to FIG. 51, illustrated is an example “Add Advice” dialog presented to a user after selecting the “Add Advice” text link on the integration toolbar 5001 of the present invention, according to a preferred embodiment of the present invention. Preferably the user may enter a title for the advice and the narrative of the information to be shared in the text box then select one or more of the various buttons to complete the advice before submitting it. As an alternative the user may highlight text within a document before selecting the “Add Advice text link to automatically “paste” the highlighted text into the narrative text box. An example of this feature is shown in FIG. 51 where the highlighted text from the document has been pasted into the narrative text box (at least embodying herein highlighting information within at least one first display area controlled by such at least one first program; at least embodying herein accessing such at least one second computer program using such at least one inter-program link; at least embodying herein automatically transferring such highlighted information to at least one second display area controlled by such at least one second computer program). (This feature is enabled for all Microsoft Application with permit the use of the integration toolbar 5001). Preferably the user may then select the “Add Category” button to add one or more categories to classify the advice in the same manner as described with reference to FIG. 43. Preferably the user may select the “Add Attachment” button to add one or more attachment to the advice in the same manner as described with reference to FIG. 44 through FIG. 47. Preferably the user may select the “Add Link” button to add one or more URL links to the advice in the same manner as described with reference to FIG. 44 through FIG. 47. Preferably the user may also select the “Options” button to set the attachment and URL link options as described with reference to FIG. 46 and FIG. 47.

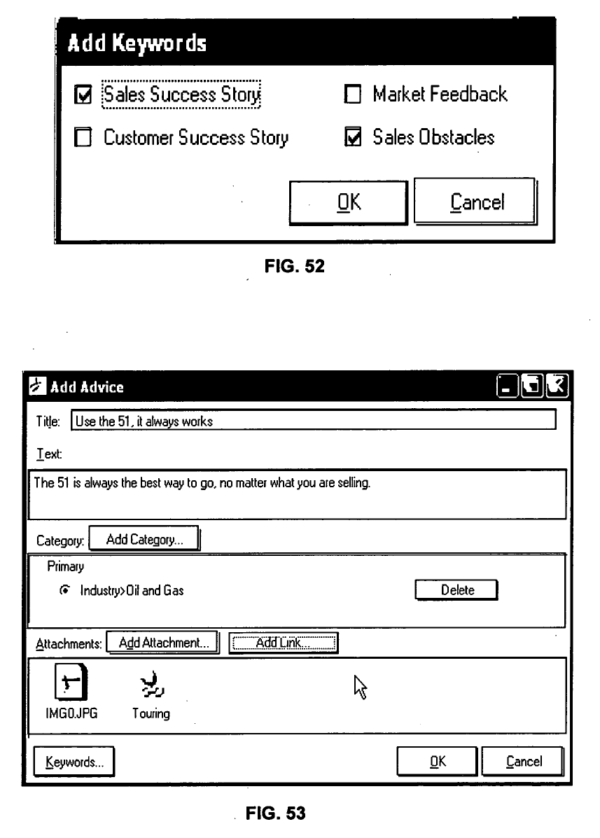

Referring now to FIG. 52, illustrated an example dialog box presented to a user after selecting the “Keywords button from within the “Add Advice” dialog box of the present invention permitting a user to select particular keywords for association with the current item of advice, according to a preferred embodiment of the present invention. Preferably, the user may select one or more keywords displayed which will best describe the advice and assist others in finding the advice after inclusion in the subject database. Selecting the “OK” button will preferably associate the selected keywords with the advice and return the user to the “Add Advice” (FIG. 51) dialog.

Referring now to FIG. 53 shown is an example screen display of a completed “Add Advice” dialog according to a preferred embodiment of the present invention. Preferably after the user has completed the steps of entering the advice, associating categories with the advice, associating it with one or more categories, and adding any documents or URL addresses as attachments a summary of the advice is presented for review and to allow the user to make any changes any of the items before submitting it. Selecting the “OK” button will preferably submit the advice and return the user to the previously active window within Microsoft Outlook.

Referring now to FIG. 54, shown is an example “Ask Questions” dialog presented to a user after selecting the “Questions (n)” text link on the integration toolbar of the present invention, according to a preferred embodiment of the present invention. Preferably the “Ask Questions” dialog presents a list of questions awaiting answers from the user. The user may select any one of the items on the list and respond to the question in the same manner as described with reference to FIG. 48 through FIG. 51.

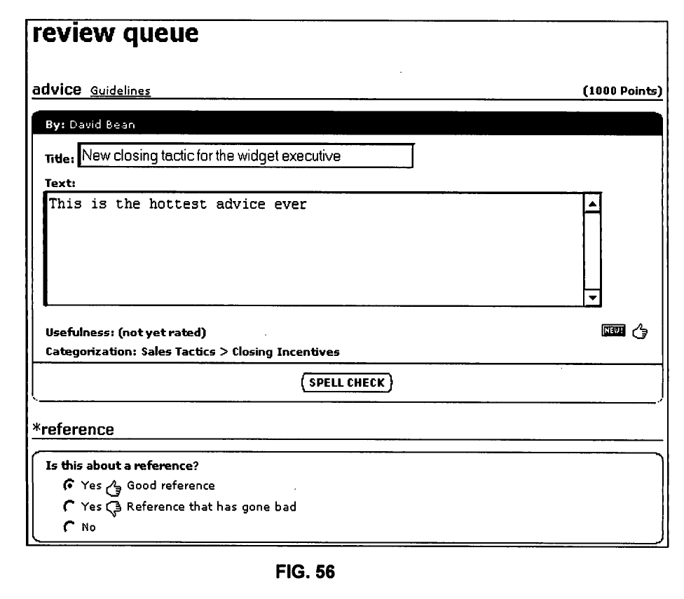

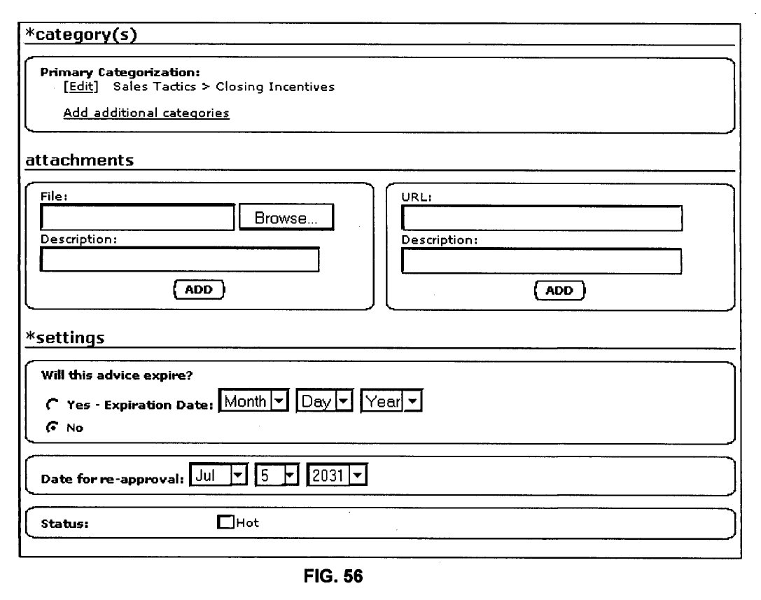

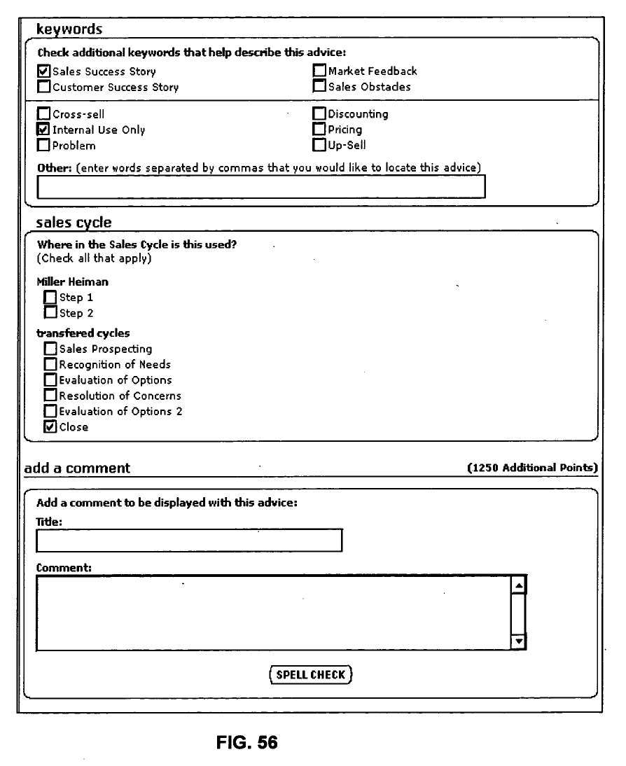

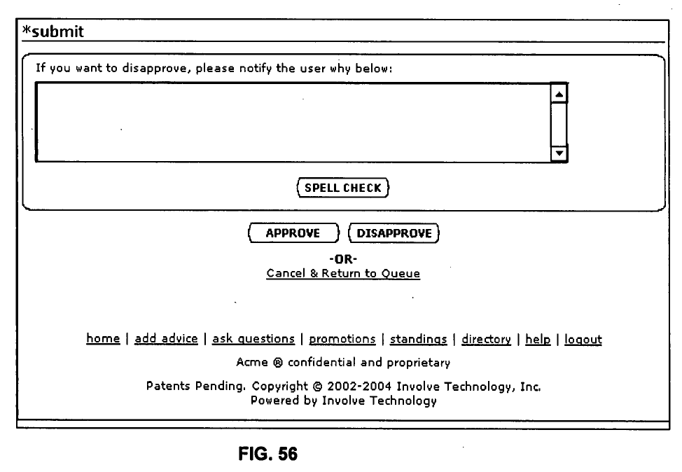

Referring now to FIG. 55, illustrated is an example “Approvals” dialog presented to a user after selecting the “Approvals (n)” text link on the integration toolbar of the present invention, according to a preferred embodiment of the present invention. Preferably the “Approvals” dialog presents a list of advice that has been submitted for approval by the user. The user may select any one of the items on the list and approve or disapprove it in the manner as described with reference to FIG. 56.

Referring now to FIG. 56, shown is an illustration of the screen display used to review and approve submitted advice according to a preferred embodiment of the present invention. Preferably each user authorized to review and approve advice submitted for inclusion in the subject database will use this screen display. Preferably each authorized user will review and edit advice submissions for accuracy appropriateness and completeness. As shown, preferably all aspects of a submitted advice may be modified by the approving user. At the conclusion of his or her review preferably the approving user will either approve the submitted advice or disapprove it and optionally provide an explanation for use by the user who submitted the advice.

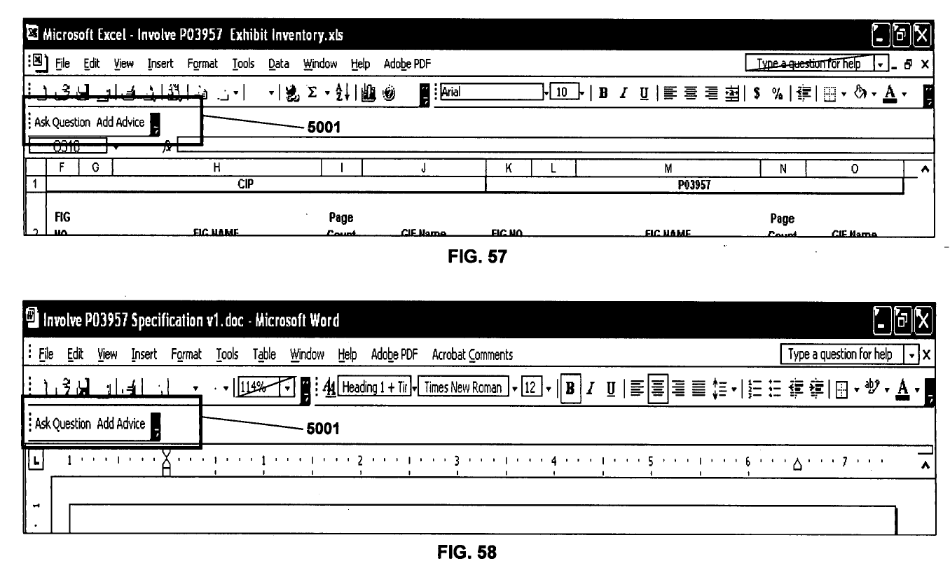

Referring now to FIG. 57, shown is an illustration of the integration toolbar 5001 of the present invention presented within Microsoft Excel, according to a preferred embodiment of the present invention (at least embodying herein wherein such at least one other computer-based system comprises at least one computer-based spreadsheet system).

Referring now to FIG. 58 shown is an illustration of the integration toolbar 5001 of the present invention is presented within Microsoft Word, according to a preferred embodiment of the present invention (at least embodying herein wherein such at least one other computer-based system comprises at least one computer-based word processing system).

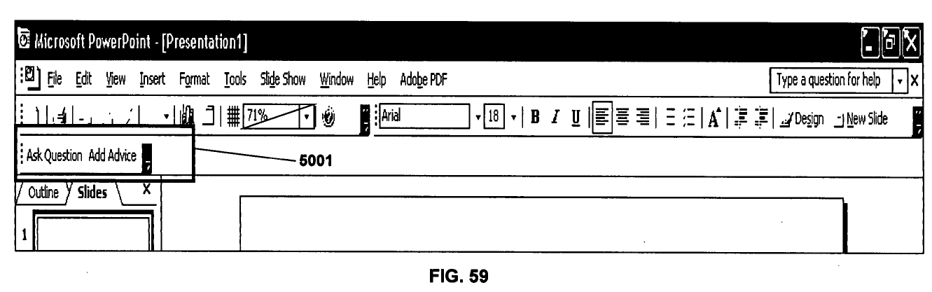

Referring now to FIG. 59 shown is an illustration of the integration toolbar 5001 of the present invention is presented within Microsoft PowerPoint, according to a preferred embodiment of the present invention (at least embodying herein wherein such at least one other computer-based system comprises at least one computer-based presentation preparation system).

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

1) An Internet client-server system, relating to assisting a group of users with at least one common goal to capture and search, in at least one database, offered knowledge, relevant to such at least one common goal, of a plurality of such users for the benefit of at least one of such users, comprising:
a) computer interface means for individually capturing at least one experience of at least some of such plurality of such users;
b) computer database means for storing such captured at least one experience associated with at least one of a plurality of kinds of experience;
c) computer interface means for user-searching to select at least one desired kind of such stored at least one experience;
d) computer processor means for performing such user-searching;
e) computer interface means for presenting search results of such performed user-searching;
f) computer processor means for automatically selecting, relating to at least one request formulated to request specified knowledge about at least one of such plurality of kinds of experience, at least one user of such plurality of users to receive such at least one request for such specified knowledge;
g) computer processor means for automatically sending such at least one request for such specified knowledge to such at least one user;
h) computer processor means for receiving at least one reply from such at least one user to such at least one request for such specified knowledge; and
i) computer processor means for adding such received specified knowledge to such at least one database.

2) An Internet client-server system relating to assisting a group of users with at least one common goal to capture and search, in at least one database, offered knowledge, relevant to such at least one common goal, of a plurality of such users for the benefit of at least one of such users, comprising:
a) computer interface means for individually capturing at least one experience of at least some of such plurality of such users;
b) computer database means for storing such captured at least one experience associated with at least one of a plurality of kinds of experience;
c) computer interface means for user-searching to select at least one desired kind of such stored at least one experience;
d) computer processor means for performing such user-searching;
e) computer interface means for presenting search results of such performed user-searching; and
f) computer integration means for providing from within at least one other computer-based system at least one first button for accessing such interface means for user-searching to select at least one desired kind of such stored at least one experience.

3) The Internet client-server system according to claim 2 further comprising:
a) computer integration means for providing from within such at least one other computer-based system at least one second button for accessing such computer interface means for individually capturing at least one experience of at least some of such plurality of such users; and
b) computer integration means for providing from within such at least one other computer-based system at least one third button for accessing computer interface means for formulating at least one request for such specified knowledge.

4) The Internet client-server system according to claim 2 further comprising:
a) computer integration means for providing from within such at least one other computer-based system at least one other button for accessing computer interface means for approving such at least one stored experience;
b) computer integration means for providing from within such at least one other computer-based system at least one additional other button for accessing computer interface means for responding to such at least one formulated request for such specified knowledge;
c) computer integration means for providing from within such at least one other computer-based system at least one yet additional other button for accessing computer interface means for displaying at least one web page of such Internet client-server system.

5) The Internet client-server system according to claim 2 wherein such at least one other computer-based system comprises at least one computer-based email system.

6) The Internet client-server system according to claim 2 wherein such at least one other computer-based system comprises at least one computer-based word processing system.

7) The. Internet client-server system according to claim 2 wherein such at least one other computer-based system comprises at least one computer-based spreadsheet system.

8) The Internet client-server system according to claim 2 wherein such at least one other computer-based system comprises at least one computer-based presentation preparation system.

9) The Internet client-server system according to claim 2 wherein such at least one other computer-based system is manufactured by Microsoft Corporation.

10) The Internet client-server system according to claim 2 further comprising:
a) computer processor means for automatically selecting, for at least one request formulated for such specified knowledge about at least one of such plurality of topics, at least one user of such plurality of selected users to receive such at least one request for such specified knowledge;
b) computer processor means for automatically sending such at least one request for such specified knowledge to such at least one user;
c) computer processor means for receiving at least one reply from such at least one user to such at least one request for such specified knowledge; and
d) computer processor means for adding such received specified knowledge to such at least one database.

11) An Internet client-server program, relating to assisting at least one group of users having at least one common goal to capture and search, in at least one database, offered knowledge, relevant to such at least one common goal, of a plurality of such users for the benefit of at least one of such users, comprising the steps of:
a) individually capturing for such at least one database at least one experience of at least some of such plurality;
b) storing in such at least one database such experience;
c) user-searching to select at least one desired kind of stored experience;
d) performing such user-searching; and
e) presenting search results;
f) wherein such at least one database may be initially and continuously seeded by the steps of
i) formulating at least one request for such knowledge relevant to such at least one common goal,
ii) automatically selecting at least one user of such group of users to receive such at least one request for such relevant knowledge,
iii) automatically sending such at least one request for such relevant knowledge to such at least one user,
iv) receiving at least one reply from such at least one user to such at least one request for such relevant knowledge, and
v) adding such received relevant knowledge to such at least one database.

12) An Internet client-server program, relating to assisting at least one group of users having at least one common goal to capture and search, in at least one database, offered knowledge, relevant to such at least one common goal, of a plurality of such users for the benefit of at least one of such users, comprising the steps of:
a) individually capturing for such at least one database at least one experience of at least some of such plurality;
b) storing in such at least one database such experience;
c) user-searching, using at least one natural-language word, to select at least one desired kind of stored experience;
d) performing such user-searching;
e) presenting search results; and
f) providing from within at least one other computer-based system at least one first button for user-searching to select at least one desired kind of stored experience.

13) The Internet client-server program according to claim 12 further comprising the steps of:
a) providing from within such at least one other computer-based system at least one second button for individually capturing for such at least one database at least one experience of at least some of such plurality; and
b) providing from within such at least one other computer-based system at least one third button for formulating at least one request for such specified knowledge.

14) The Internet client-server program according to claim 12 further comprising the steps of:
a) providing from within at least one other computer-based system at least one other button for approving such at least one stored experience;
b) providing from within at least one other computer-based system at least one additional other button for responding to such at least one formulated request for such specified knowledge;
c) providing from within at least one other computer-based system at least one yet additional other button for displaying at least one web page of such Internet client-server system.

15) The Internet client-server program according to claim 12 wherein such at least one other computer-based system comprises at least one computer-based email system.

16) The Internet client-server program according to claim 12 wherein such at least one other computer-based system comprises at least one computer-based word processing system.

17) The Internet client-server program according to claim 12 wherein such at least one other computer-based system comprises at least one computer-based spreadsheet system.

18) The Internet client-server program according to claim 12 wherein such at least one other computer-based system comprises at least one computer-based presentation preparation system.

19) The Internet client-server program according to claim 12 wherein such at least one other computer-based system is manufactured by Microsoft Corporation.

20) The Internet client-server program according to claim 12 further comprising the steps of:
a) initially and continuously seeding such at least one database;
b) wherein such step of initially and continuously seeding such at least one database comprises the steps of
i) formulating at least one request for such knowledge relevant to such at least one common goal,
ii) automatically selecting at least one user of such group of users to receive such at least one request for such relevant knowledge,
iii) automatically sending such at least one request for such relevant knowledge to such at least one user,
iv) receiving at least one reply from such at least one user to such at least one request for such relevant knowledge, and
v) adding such received relevant knowledge to such at least one database.

21) A business system, for a developer, relating to use by customers having websites, of web computer systems of the type involving supporting a community of users interacting with at least one database to search for particular subject information, comprising the steps of:
a) providing such computer systems to comprise software management systems to directly manage such at least one database and such community of users essentially without customer website management; and
b) providing variables in such software management systems to be configurable by such customer without affecting such direct management operations;
c) wherein such software management systems comprise
i) automatically measuring efforts of each user of such community,
ii) automatically setting of goals for each user of such community, and
iii) automatically managing at least one reward system to reward management efforts of each user of such community;
d) wherein such at least one database may be initially and continuously seeded by the steps of
i) formulating at least one request for such particular subject information;
ii) automatically selecting at least one such user to receive such at least one request for such particular subject information;
iii) automatically sending such at least one request for such particular subject information to such at least one user;
iv) receiving at least one reply from such at least one user to such at least one request for such particular subject information; and
v) adding such received particular subject information to such at least one database.

22) A business system, for a developer, relating to use by customers having websites, of web computer systems of the type involving supporting a community of users interacting with at least one database to search for particular subject information, comprising the steps of:
a) providing for such computer systems to comprise software management systems to directly manage such at least one database and such community of users essentially without customer website management;
b) providing for variables in such software management systems to be configurable by such customer without affecting such direct management operations; and
c) providing from within at least one other computer-based system at least one first button to so search for such particular subject information; and
d) wherein such software management systems comprise
i) automatically measuring efforts of each user of such community,
ii) automatically setting of goals for each user of such community, and
iii) automatically managing at least one reward system to reward management efforts of each user of such community.

23) The business system according to claim 22 further comprising:
a) providing from within such at least one other computer-based system at least one second button to individually capture for such at least one database at least one such particular subject information; and
b) providing from within such at least one other computer-based system at least one third button for formulating at least one user request for at least one such particular subject information.

24) The business system according to claim 22 further comprising:
a) providing from within such at least one other computer-based system at least one other button for approving at least one such particular subject information;
b) providing from within such at least one other computer-based system at least one additional other button for responding to such at least one request for such particular subject information; and
c) providing from within such at least one other computer-based system at least one yet additional other button for displaying at least one web page of such web computer system.

25) The business system according to claim 22 wherein such at least one other computer-based system comprises at least one computer-based email system.

26) The business system according to claim 22 wherein such at least one other computer-based system comprises at least one computer-based word processing system.

27) The business system according to claim 22 wherein such at least one other computer-based system comprises at least one computer-based spreadsheet system.

28) The business system according to claim 22 wherein such at least one other computer-based system comprises at least one computer-based presentation preparation system.

29) The business system according to claim 22 wherein such at least one other computer-based system is manufactured by Microsoft Corporation.

30) The business system according to claim 22 wherein such at least one database may be initially and continuously seeded by the steps of:
a) formulating at least one request for such particular subject information;
b) automatically selecting at least one such user to receive such at least one request for such particular subject information;
c) automatically sending such at least one request for such particular subject information to such at least one user;
d) receiving at least one reply from such at least one user to such at least one request for such particular subject information; and
e) adding such received particular subject information to such at least one database.

31) A business system, supplied by a developer, relating to use by customers having websites comprising web server computer systems of the type involving supporting a community of users, having client computer systems, interacting with at least one database to search for particular subject information, comprising providing, for website use:
a) computer software means for direct automatic management of such at least one database and such community of users essentially without customer website management; and
b) computer software means for permitting such customer to configure a large set of variables in such computer software means for direct automatic management of such at least one database and such community of users without affecting full operation of such direct automatic management;
c) wherein such computer software means for direct automatic management of such at least one database and such community of users essentially without customer website management comprises
i) computer software means for automatically measuring efforts of each user of such community,
ii) computer software means for automatic setting of goals for each user of such community, and
d) computer software means for automatically managing a reward system to reward efforts of each user of such community; and
e) computer software means for
i) formulating at least one request for such particular subject information,
ii) automatically selecting at least one such user to receive such at least one request for such particular subject information,
iii) automatically sending such at least one request for such particular subject information to such at least one user,
iv) receiving at least one reply from such at least one user to such at least one request for such particular subject information, and
v) adding such received particular subject information to such at least one database.

32) A business system, supplied by a developer, relating to use by customers having websites comprising web server computer systems of the type involving supporting a community of users, having client computer systems, interacting with at least one database to search for particular subject information, comprising providing, for website use:
a) computer software means for direct automatic management of such at least one database and such community of users essentially without customer website management; and
b) computer software means for permitting such customer to configure a large set of variables in such computer software means for direct automatic management of such at least one database and such community of users without affecting full operation of such direct automatic management;
c) wherein such computer software means for direct automatic management of such at least one database and such community of users essentially without customer website management comprises
i) computer software means for automatically measuring efforts of each user of such community,
ii) computer software means for automatic setting of goals for each user of such community, and
iii) computer software means for automatically managing a reward system to reward efforts of each user of such community; and
d) computer integration means for providing from within at least one other computer-based system at least one first button for accessing at least one such client computer system to so search for such particular subject information.

33) The business system according to claim 32 further comprising:
a) computer integration means for providing from within such at least one other computer-based system at least one second button to individually capture for such at least one database at least one such particular subject information; and
b) computer integration means for providing from within such at least one other computer-based system at least one third button for formulating at least one user request for at least one such particular subject information.

34) The business system according to claim 32 further comprising:
a) computer integration means for providing from within such at least one other computer-based system at least one other button for approving at least one such particular subject information;
b) computer integration means for providing from within such at least one other computer-based system at least one additional other button for responding to such at least one request for such particular subject information; and
c) computer integration means for providing from within such at least one other computer-based system at least one yet additional other button for displaying at least one web page of such web computer system.

35) The business system according to claim 32 wherein such at least one other computer-based system comprises at least one computer-based email system.

36) The business system according to claim 32 wherein such at least one other computer-based system comprises at least one computer-based word processing system.

37) The business system according to claim 32 wherein such at least one other computer-based system comprises at least one computer-based spreadsheet system.

38) The business system according to claim 32 wherein such at least one other computer-based system comprises at least one computer-based presentation preparation system.

39) The business system according to claim 32 wherein such at least one other computer-based system is manufactured by Microsoft Corporation.

40) A business system, supplied by a developer, relating to use by customers having websites comprising web server computer systems of the type involving supporting a community of users, having client computer systems, interacting with at least one database searching for particular subject information, comprising providing, for website use:
a) computer software means for direct automatic management of such at least one database and such community of users essentially without customer website management;
b) computer software means for permitting such customer to configure a large set of variables in such computer software means for direct automatic management of such at least one database and such community of users without affecting full operation of such direct automatic management;
c) wherein such computer software means for direct automatic management of such at least one database and such community of users essentially without customer website management comprises
i) computer software means for automatically measuring efforts of each user of such community,
ii) computer software means for automatic setting of goals for each user of such community, and
iii) computer software means for automatically managing a reward system to reward efforts of each user of such community;
d) computer processor means for
i) formulating at least one request for such particular subject information,
ii) automatically selecting at least one such user to receive such at least one request for such particular subject information,
iii) automatically sending such at least one request for such particular subject information to such at least one user,
iv) receiving at least one reply from such at least one user to such at least one request for such particular subject information, and
v) adding such received particular subject information to such at least one database; and
e) computer integration means for providing from within at least one other computer-based system at least one first button for accessing at least one such client computer system to so search for such particular subject information.

41) A computer system, relating to assisting automatic request and receipt of specified information about at least one plurality of topics from at least one plurality of selected users to create at least one database of such information and to improve the usefulness and quality of such at least one database without substantial management, comprising the steps of:
a) formulating at least one request for such specified information about at least one of such plurality of topics;
b) automatically selecting at least one user of such plurality of selected users to receive such at least one request for such specified information;
c) automatically sending such at least one request for such specified information to such at least one user;
d) receiving at least one reply from such at least one user to such at least one request for such specified information; and
e) adding such received specified information to such at least one database.

42) The computer system according to claim 41, wherein the step of formulating at least one request for such specified information about at least one of such plurality of topics comprises the steps of:
a) identifying at least one topic for which such specified information is to be requested;
b) formulating such at least one request for such specified information about at least one of such plurality of topics;
c) assigning at least one priority to each such at least one request; and
d) assigning each such at least one request to at least one primary topic.

43) The computer system according to claim 41, wherein the step of automatically sending such at least one request for such specified information to such at least one user comprises the steps of:
a) setting the daily maximum number of such requests to be sent to such at least one user;
b) specifying the timeframe for re-sending each such at least one request to such at least one user;
c) selecting each such at least one user to receive such at least one request;
d) sending such at least one request to such at least one user;
e) recording content of such at least one request and delivery information for such at least one user; and
f) adding at least one transmittal record, which includes at least one identifier of such at least one request, of delivery information for such at least one user and date and time of transmission, to such at least one database.

44) The computer system according to claim 43, wherein the step of sending such at least one request to such at least one user comprises the steps of:
a) identifying such plurality of users with known expertise in such primary topic of such at least one request;
b) for each such at least one request, referring to the latest such at least one transmittal record for each identified at least one user and such at least one request combination;
c) selecting only those users who have not received such request within the defined timeframe;
d) limiting the number of such requests sent daily to each of such selected users knowledgeable about such at least one of such plurality of topics;
e) limiting the number of such selected users which may receive such at least one request to a daily maximum percentage of all possible such selected users; and
f) sending such at least one request to selected at least one user who has not received such at least one request within such specified timeframe for each such at least one request.

45) The computer system according to claim 41, wherein the step of adding such received specified information to such at least one database comprises the steps of:
a) adding at least one receipt record, which includes at least one identifier of such at least one request, reply information for such at least one user and date and time of receipt of, to such at least one database;
b) approval of such at least one reply information by such at least one authorized user;
c) adding such at least one reply information to such at least one database.

46) The computer system according to claim 41 wherein the specified information about the at least one plurality of topics comprises at least one rating of at least one reply of at least one other user.

47) The computer system according to claim 46 wherein such at least one selected user comprises a person knowledgeable about such at least one selected topic.

48) A computer system, relating to assisting automatic request and receipt of specified information about at least one plurality of topics from at least one plurality of selected users to create at least one database of such information and to improve the usefulness and quality of such at least one database without substantial management:
a) processor means for automatically selecting, for at least one request formulated for such specified information about at least one of such plurality of topics, at least one user of such plurality of selected users to receive such at least one request for such specified information;
b) processor means for automatically sending such at least one request for such specified information to such at least one user;
c) processor means for receiving at least one reply from such at least one user to such at least one request for such specified information; and
d) processor means for adding such received specified information to such at least one database.

49) The computer system according to claim 48, wherein such processor means for automatically selecting, for at least one request formulated for such specified information about at least one of such plurality of topics, at least one user of such plurality of selected users to receive such at least one request for such specified information comprises:
a) processor means for identifying at least one topic for which such specified information is to be requested;
b) computer input means for assisting formulating such at least one request for such specified information about at least one of such plurality of topics;
c) computer input means for assisting assigning at least one priority to each such at least one request;
d) computer input means for assisting assigning each such at least one request to at least one primary topic; and
e) processor means for automatically selecting at least one user of such plurality of selected users to receive such at least one request for such specified information.

50) The computer system according to claim 48, wherein such processor means for automatically sending such at least one request for such specified information to such at least one user comprises:
a) computer input means for assisting setting the daily maximum number of such requests to be sent such to at least one user;
b) computer input means for assisting specifying the timeframe for re-sending each such at least one request to such at least one user;
c) processor means for selecting each such at least one user to receive such at least one request;
d) processor means for sending such at least one request to such at least one user;
e) processor means for recording content of such at least one request and delivery information for such at least one user; and
f) processor means adding at least one transmittal record, which includes at least one identifier of such at least one request, of delivery information for such at least one user and date and time of transmission, to such at least one database.

51) The computer system according to claim 50, wherein such processor means for sending such at least one request to such at least one user comprises:
a) processor means for identifying such plurality of users with known expertise in such primary topic of such at least one request;
b) for each such at least one request, processor means for referring to the latest such at least one transmittal record for each identified at least one user and such at least one request combination;
c) processor means for selecting only those users who have not received such request within the defined timeframe;
d) processor means for limiting the number of such requests sent daily to each of such selected users knowledgeable about such at least one of such plurality of topics;
e) processor means for limiting the number of such selected users which may receive such at least one request to a daily maximum percentage of all possible such selected users; and
f) processor means for sending such at least one request to selected at least one user who has not received such at least one request within such specified timeframe for each such at least one request.

52) The computer system according to claim 48, wherein such processor means for adding such received specified information to such at least one database comprises:
a) processor means for adding at least one receipt record, which includes at least one identifier of such at least one request, reply information for such at least one user and date and time of receipt of, to such at least one database;
b) processor means for approval of such at least one reply information by such at least one authorized user; and
c) processor means for adding such at least one reply information to such at least one database.

53) The computer system according to claim 48 wherein the specified information about the at least one plurality of topics comprises at least one rating of at least one reply of at least one other user.

54) The computer system according to claim 53 wherein such at least one selected user comprises a person knowledgeable about such at least one selected topic.

55) A computer method relating to automatically transferring displayed information between computer programs comprising the steps of:
a) establishing at least one inter-program link between at least one first computer program and at least one second computer program;
b) starting such at least one first computer program;
c) highlighting information within at least one first display area controlled by such at least one first program;
d) accessing such at least one second computer program using such at least one inter-program link; and
e) automatically transferring such highlighted information to at least one second display area controlled by such at least one second computer program.
